(19) United States
(12) Patent Application Publication
(10) Pub. No.: US 2021/0395459 A1
(43) Pub. Date: Dec. 23, 2021

(54) THERMOSETTING RESIN COMPOSITION AND METHOD FOR MANUFACTURING SAME

(71) Applicant: SAKAI CHEMICAL INDUSTRY CO., LTD., Sakai-shi, Osaka (JP)

(72) Inventors: Hiromi KIDA, Osaka (JP); Atsushi MIYATA, Osaka (JP); Shinji IKESHITA, Osaka (JP); Keita KOBAYASHI, Fukushima (JP)

(21) Appl. No.: 16/759,973

(22) PCT Filed: Oct. 30, 2018
(86) PCT No.: PCT/JP2018/040382

§ 371 Date: Apr. 28, 2020

(30) Foreign Application Priority Data
Oct. 31, 2017 (JP) 2017-211121
Dec. 22, 2017 (JP) 2017-246539
Jul. 2, 2018 (JP) 2018-126036

(51) Int. Cl. C08G 73/12; C08G 59/06; C08G 59/50; C08K 5/378; C08K 5/132; C08K 5/3415; C08L 63/00

(52) U.S. Cl. CPC C08G 73/126; C08G 73/122; C08G 59/066; C08G 59/5033; C08L 2203/20; C08K 5/132; C08K 5/3415; C08L 63/00; C08L 2201/08; C08K 5/378

(57) ABSTRACT

The present invention provides a resin composition which has excellent handleability and which provides a cured product having excellent toughness and heat resistance. The present invention relates to a thermosetting resin composition including an allyl compound (A) containing at least two or more allyl groups and one or more benzene rings in a molecule, a maleimide compound (B) containing at least two or more maleimide groups in a molecule, a thiol compound (C) containing at least two or more thiol groups in a molecule, and a cyclic compound (D) containing at least two or more hydroxyl groups in a molecule.

### TECHNICAL FIELD

The present invention relates to a thermosetting resin composition and a manufacturing method for the thermosetting resin composition.

### BACKGROUND ART

Thermosetting resins containing a bismaleimide group, which contains an unsaturated bond and an imide bond, have excellent electrical properties and thermal properties (also referred to as heat resistance). Such thermosetting resins have been widely used as various materials such as electronic and electrical component materials and structural materials in industrial fields. However, a resin cured product obtained by polymerizing a bismaleimide compound alone has excellent thermal properties, but is very brittle and has poor mechanical properties.

With respect to improvers for the properties of such a resin cured product consisting only of a bismaleimide compound, the following compositions are proposed such as a resin composition obtained by reacting an aromatic bismaleimide compound with a diamine compound (Patent Literature 1); a resin composition including as essential constituents an aromatic bismaleimide compound, an aromatic diamine compound, and a compound in which hydroxyl groups are bonded individually to two or more adjacent carbon atoms constituting an aromatic ring (Patent Literature 2); and a resin composition including a bismaleimide compound and an allyl compound and a thermosetting resin composition including a bismaleimide compound, an allyl compound, and a thiol compound (Patent Literatures 3 and 4).

### CITATION LIST

### Patent Literature

Patent Literature 1: JP S46-23250 B
Patent Literature 2: JP 2011-84711 A
Patent Literature 3: JP 555-39242 B
Patent Literature 4: JP 2016-74902 A

### SUMMARY OF INVENTION

### Technical Problem

Resin compositions including a bismaleimide compound and a different compound in combination have been proposed as described above. However, the resin composition of Patent Literature 1 provides a cured product having enhanced mechanical properties but insufficient heat resistance. The resin composition of Patent Literature 2 is produced from raw materials which are all solid, and the raw materials are hardly uniformly dispersed when used in a solventless system. The resin composition of Patent Literature 3 containing a liquid allyl compound as a curing agent has good handleability and provides a cured product having improved mechanical properties, but insufficient heat resistance. The resin composition of Patent Literature 4 provides a cured product having improved heat resistance and mechanical properties, but the period from hot melting to gelation is short due to addition of a thiol compound, leading to a problem in handleability of the resin composition.

Such conventional resin compositions containing a bismaleimide compound are all unsatisfactory in properties. Thus, a resin composition which has excellent handleability and which provides a cured product having excellent toughness and heat resistance has been required.

In view of the current situation described above, the present invention aims to provide a resin composition which has excellent handleability and which provides a cured product having excellent toughness and heat resistance.

### Solution to Problem

The present inventors have conducted various studies on a resin composition which has excellent handleability and which provides a cured product having excellent toughness and heat resistance, and found that a resin composition including an allyl compound (A) containing at least two or more allyl groups and one or more benzene rings in a molecule, a maleimide compound (B) containing at least two or more maleimide groups in a molecule, a thiol compound (C) containing at least two or more thiol groups in a molecule, and further a cyclic compound (D) containing at least two or more hydroxyl groups in a molecule has excellent handleability, and provides a cured product having excellent toughness and heat resistance. Thereby, the present invention has been completed.

That is, one aspect of the present invention relates to a thermosetting resin composition including: an allyl compound (A) containing at least two or more allyl groups and one or more benzene rings in a molecule; a maleimide compound (B) containing at least two or more maleimide groups in a molecule; a thiol compound (C) containing at least two or more thiol groups in a molecule; and a cyclic compound (D) containing at least two or more hydroxyl groups in a molecule.

The cyclic compound (D) is preferably an aromatic compound or a quinone compound.

The thermosetting resin composition preferably contains the cyclic compound (D) in a ratio of 0.01 parts by weight or more and 6.0 parts by weight or less relative to 100 parts by weight of the maleimide compound (B).

The thermosetting resin composition preferably contains the cyclic compound (D) in a ratio of 0.01 parts by weight or more and less than 1.2 parts by weight relative to 100 parts by weight of the maleimide compound (B).

The thermosetting resin composition also preferably contains the cyclic compound (D) in a ratio of 1.2 parts by weight or more and 6.0 parts by weight or less relative to 100 parts by weight of the maleimide compound (B).

The thermosetting resin composition preferably further includes a thermosetting resin other than the maleimide compound (B).

The thermosetting resin other than the maleimide compound (B) is preferably an epoxy resin.

A sum of weights of the components (A), (B), (C), and (D) is preferably 10 parts by weight or more and 80 parts by weight or less relative to 100 parts by weight of the thermosetting resin other than the maleimide compound (B).

Another aspect of the present invention relates to a thermosetting resin obtained by curing the thermosetting resin composition.

Still another aspect of the present invention relates to a manufacturing method for a thermosetting resin composition, including mixing an allyl compound (A) containing at least two or more allyl groups and one or more benzene rings in a molecule, a maleimide compound (B) containing at least two or more maleimide groups in a molecule, a thiol compound (C) containing at least two or more thiol groups in a molecule, and a cyclic compound (D) containing at least two or more hydroxyl groups in a molecule.

Preferably, the mixing is either a step of mixing the allyl compound (A) and the cyclic compound (D) to obtain a mixture, followed by mixing the thiol compound (C) and the maleimide compound (B) in the stated order with the mixture or a step of mixing the maleimide compound (B) and the cyclic compound (D) to obtain a mixture, followed by mixing the allyl compound (A) and the thiol compound (C) in the stated order with the mixture.

The manufacturing method for a thermosetting resin composition preferably further includes, after the mixing, mixing a thermosetting resin other than the maleimide compound (B) with the mixture.

The manufacturing method for a thermosetting resin composition preferably further includes, after the mixing, partially carrying out a polymerization reaction of at least one of the components (A) to (D) in the mixture and then mixing a thermosetting resin other than the maleimide compound (B) with the mixture.

### Advantageous Effects of Invention

The thermosetting resin composition of the present invention has excellent handleability, and provides a cured product having excellent toughness and heat resistance. Thus, the resin composition is suitable as materials such as electronic and electrical component materials and fiber-reinforced composite materials.

### DESCRIPTION OF EMBODIMENTS

The following specifically describes preferred embodiments of the present invention. The present invention is not limited to these embodiments, and suitable modifications may be made without departing from the gist of the present invention.

### 1. Thermosetting Resin Composition

A thermosetting resin composition of the present invention includes an allyl compound (A) containing at least two or more allyl groups and one or more benzene rings in a molecule, a maleimide compound (B) containing at least two or more maleimide groups in a molecule, a thiol compound (C) containing at least two or more thiol groups in a molecule, and further a cyclic compound (D) containing at least two or more hydroxyl groups in a molecule.

Although the reason why the thermosetting resin composition containing the cyclic compound (D) that contains such specific functional groups has excellent handleability and provides a cured product (thermosetting resin) having excellent toughness and heat resistance is unknown, it is presumably due to the structural change of the resin by reaction between the maleimide compound (B) and the cyclic compound (D). As shown in the below-described examples, when the cyclic compound (D) is added to the resin composition free from the thiol compound (C), the heat resistance of the cured product is low. This indicates that the technical significance of the thermosetting resin composition of the present invention is that the thermosetting resin composition contains the above specific four components. The thermosetting resin composition of the present invention may contain the compounds (A) to (D) at least partially polymerized by partially carrying out a polymerization reaction of at least one of the components (A) to (D) by photochemical or heat reaction in the below-described manufacturing method for a thermosetting resin composition of the present invention.

First, the following describes the cyclic compound (D), which is the most important feature of the thermosetting resin composition of the present invention, and then describes other components.

All of the amounts of the compounds (A) to (D) in the thermosetting resin composition described below are the amounts in the composition before partially carrying out a polymerization reaction of at least one of the components (A) to (D).

### <Cyclic Compound (D)>

The cyclic compound (D) in the present invention is a cyclic compound containing at least two or more hydroxyl groups in a molecule.

The thermosetting resin composition containing the cyclic compound (D) that contains two or more hydroxyl groups has excellent handleability, and provides a cured product having improved heat resistance. The cyclic compound (D) more preferably has three or more hydroxyl groups. The cyclic compound (D) having three or more hydroxyl groups has more improved handleability.

The cyclic compound (D) may or may not contain a functional group other than or in addition to a hydroxyl group. The functional group other than a hydroxyl group, if present, may be a functional group selected from the group consisting of a nitro group, a nitroso group, a sulfonyl group, an amino group, and an alkyl group.

The cyclic compound (D) may be any compound having a cyclic structure that contains the above specific functional groups. The cyclic structure may be a hydrocarbon ring, a heterocyclic ring, an alicyclic structure, or an aromatic ring. The cyclic compound (D) is preferably an aromatic compound or a quinone compound.

Use of an aromatic compound or a quinone compound enables the resin composition of the present invention to provide a cured product, i.e., a thermosetting resin, having better heat resistance.

When the cyclic compound (D) is an aromatic compound, the aromatic ring in the cyclic compound (D) may be an aromatic hydrocarbon ring such as a benzene ring, a naphthalene ring, or an anthracene ring or a heteroaromatic ring such as a furan ring, a thiophene ring, an imidazole ring, or a pyridine ring. Preferred among these are a benzene ring and a naphthalene ring.

When the cyclic compound (D) is a quinone compound, it may be any quinone compound such as a benzoquinone compound, a naphthoquinone compound, or an anthraquinone compound. Preferred among these is a benzoquinone compound.

Specific examples of the cyclic compound (D) include pyrogallol, 1,2,4-benzenetriol, catechol, hydroquinone, dihydroxynaphthalene, and tetrahydroxybenzophenone. Preferred among these are dihydroxynaphthalene, pyrogallol, and 1,2,4-benzenetriol.

The thermosetting resin composition of the present invention may contain any amount of the cyclic compound (D). Preferably, it contains the cyclic compound (D) in a ratio of 0.01 parts by weight or more and 6.0 parts by weight or less relative to 100 parts by weight of the maleimide compound (B). The thermosetting resin composition of the present invention containing the cyclic compound (D) in such a ratio has much better handleability. The thermosetting resin obtained by curing the thermosetting resin composition of the present invention also has much better toughness and heat resistance.

With respect to the above described ratio, the thermosetting resin composition of the present invention preferably contains the cyclic compound (D) in a ratio of 0.01 parts by weight or more and less than 1.2 parts by weight relative to 100 parts by weight of the maleimide compound (B). With such a ratio, the thermosetting resin obtained by curing the thermosetting resin composition of the present invention has much better heat resistance. To obtain a thermosetting resin having much better heat resistance, the amount of the cyclic compound (D) is more preferably 0.1 parts by weight or more and 1.0 part by weight or less, still more preferably 0.3 parts by weight or more and 0.8 parts by weight or less relative to 100 parts by weight of the maleimide compound (B).

For the above described ratios, it is also one of the preferred embodiment of the present invention that the thermosetting resin composition of the present invention contains the cyclic compound (D) in an amount of 1.2 parts by weight or more and 6.0 parts by weight or less relative to 100 parts by weight of the maleimide compound (B). The thermosetting resin obtained by curing the thermosetting resin composition of the present invention containing the cyclic compound (D) in such a ratio has much better bending properties. To provide a thermosetting resin having much better bending properties, the amount of the cyclic compound (D) is more preferably 1.3 parts by weight or more and 3.0 parts by weight or less, still more preferably 1.3 parts by weight or more and 2.0 parts by weight or less relative to 100 parts by weight of the maleimide compound (B).

### <Maleimide Compound (B)>

The maleimide compound (B) in the thermosetting resin composition of the present invention may be any one containing at least two or more maleimide groups in a molecule, and preferably has a structure represented by the following formula (1).

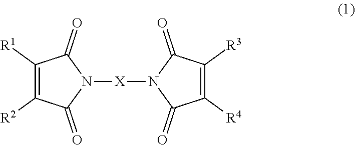

R¹ to R⁴ are each independent and are each one selected from the group consisting of a hydrogen atom, a methyl group, an ethyl group, a propyl group, a fluoro group, a chloro group, a bromo group, and an iodine group. X is an organic group containing an aromatic ring. X may contain multiple aromatic rings, and the aromatic rings may be bonded to each other through an ether, ester, amide, carbonyl, azamethylene, or alkylene group, or they may be directly bonded to each other.

The following describes X in the formula (1).

X is an organic group containing an aromatic ring. X may contain multiple aromatic rings, and the aromatic rings may be bonded to each other through an ether (—O—), ester (—O—CO—), amide (—CO—NH—), carbonyl (—CO—), azamethylene (e.g., —NH—), or alkylene (e.g., —CH₂—) group, or they may be directly bonded to each other.

Examples of the aromatic ring(s) in X include a benzene ring, a naphthalene ring, an anthracene ring, and a phenanthrene ring. It may be a heteroaromatic ring containing an atom other than a carbon atom (e.g., a nitrogen atom, a sulfur atom).

X may be a single benzene ring represented by the following formula (2) or (3), may be a combination of multiple benzene rings bonded through an alkylene group (methylene group), represented by any of the following formulas (4) to (6), or may be a combination of multiple benzene rings bonded through an ether group and an alkylene group (dimethylmethylene group: —C(CH₃)₂—), represented by the following formula (7).

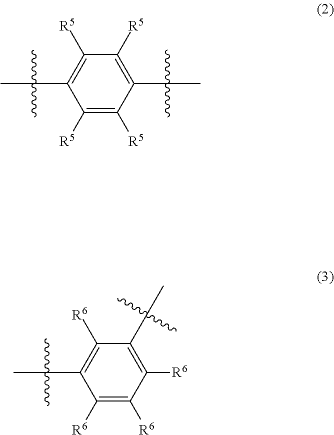

In the formulas (2) and (3), R⁵s and R⁶s may be each different from each other, and are each one selected from the group consisting of a hydrogen atom, a methyl group, an ethyl group, a propyl group, a butyl group, a methoxy group, an ethoxy group, a propoxy group, and a butoxy group.

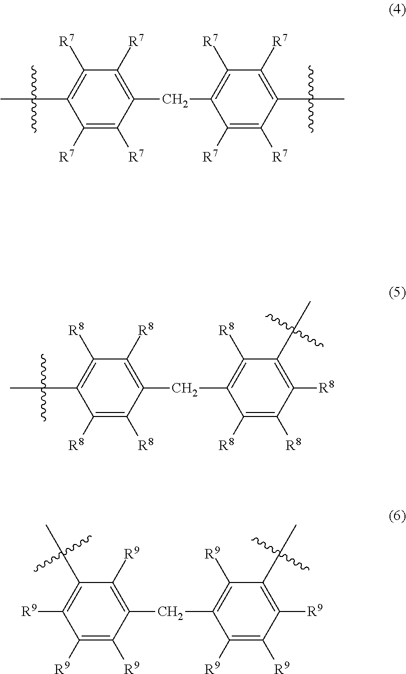

In the formulas (4) to (6), R⁷s to R⁹s may be each different from each other, and are each one selected from the group consisting of a hydrogen atom, a methyl group, an ethyl group, a propyl group, a butyl group, a methoxy group, an ethoxy group, a propoxy group, and a butoxy group.

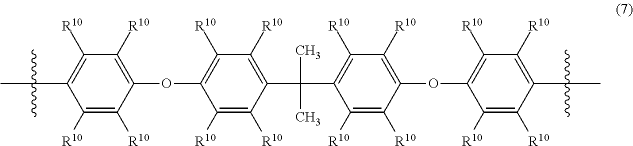

In the formula (7), R¹⁰s may be different from each other and are each one selected from the group consisting of a hydrogen atom, a methyl group, an ethyl group, a propyl group, a butyl group, a methoxy group, an ethoxy group, a propoxy group, and a butoxy group.

In particular, 4,4′-diphenylmethane bismaleimide is preferable because it increases the heat resistance of a cured resin.

In the thermosetting resin composition of the present invention, the proportion of the maleimide compound (B) is preferably 35 to 90 parts by weight based on 100 parts by weight in total of the components (A) to (D) in the thermosetting resin composition. It is more preferably 50 to 85 parts by weight, still more preferably 60 to 80 parts by weight.

### <Allyl Compound (A)>

The allyl compound (A) containing at least two or more allyl groups and one or more benzene rings in a molecule in the thermosetting resin composition of the present invention may be any one containing at least two or more allyl groups in a molecule. It is preferably a compound containing at least two or more allyl groups and one or more aromatic rings in a molecule, more preferably a compound containing at least two or more allyl groups and one or more benzene rings in a molecule.

The compound containing at least two or more allyl groups and one or more benzene rings in a molecule is preferably a diallylated bisphenol compound such as diallylated bisphenol A, diallylated bisphenol AP, diallylated bisphenol AF, diallylated bisphenol B, diallylated bisphenol BP, diallylated bisphenol C, diallylated bisphenol E, or diallylated bisphenol F; a benzene poly(2 to 6) carboxylic acid poly(2 to 6) allyl ester; or allylated novolac.

Additional examples thereof also include diallylated bisphenols obtained by diallylating bisphenol G, bisphenol M, bisphenol S, bisphenol P, bisphenol PH, bisphenol TM, or bisphenol Z.

Each of the allyl compounds (A) may be used alone or two or more of the compounds may be used.

Examples of the diallylated bisphenol A include a compound represented by the following formula (8) such as 2,2-bis[2-(2-propenyl)-4-hydroxyphenyl]propane, 2,2-bis[3-(2-propenyl)-4-hydroxyphenyl]propane, or 2-[2-(2-propenyl)-4-hydroxyphenyl]-2-[3-(2-propenyl)-4-hydroxyphenyl]propane and a compound represented by the following formula (9) such as 2,2-bis[4-(2-propenyloxy)phenyl]propane.

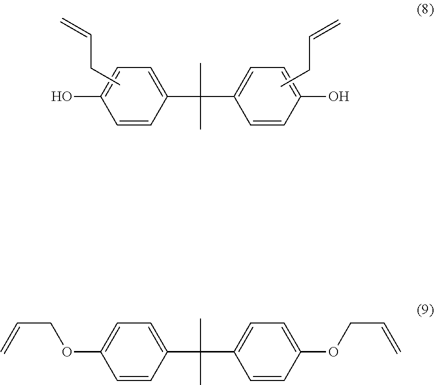

Examples of the diallylated bisphenol AP include 1,1-bis[2-(2-propenyl)-4-hydroxyphenyl]-1-phenylethane, 1,1-bis[3-(2-propenyl)-4-hydroxyphenyl]-1-phenylethane, 1-[2-(2-propenyl)-4-hydroxyphenyl]-1-[3-(2-propenyl)-4-hydroxyphenyl]propane, and 1,1-bis[4-(2-propenyloxy)phenyl]-1-phenylethane.

Examples of the diallylated bisphenol AF include 2,2-bis[2-(2-propenyl)-4-hydroxyphenyl]hexafluoropropane, 2,2-bis[3-(2-propenyl)-4-hydroxyphenyl]hexafluoropropane, 2-[2-(2-propenyl)-4-hydroxyphenyl]-2-[3-(2-propenyl)-4-hydroxyphenyl]hexafluoropropane, and 2,2-bis[4-(2-propenyloxy)phenyl]hexafluoropropane.

Examples of the diallylated bisphenol B include 2,2-bis[2-(2-propenyl)-4-hydroxyphenyl]butane, 2,2-bis[3-(2-propenyl)-4-hydroxyphenyl]butane, 2-[2-(2-propenyl)-4-hydroxyphenyl]-2-[3-(2-propenyl)-4-hydroxyphenyl]butane, and 2,2-bis[4-(2-propenyloxy)phenyl]butane.

Examples of the diallylated bisphenol BP include bis[2-(2-propenyl)-4-hydroxyphenyl]diphenylmethane, bis[3-(2-propenyl)-4-hydroxyphenyl]diphenylmethane, [2-(2-propenyl)-4-hydroxyphenyl][3-(2-propenyl)-4-hydroxyphenyl]diphenylmethane, and bis[4-(2-propenyloxy)phenyl]diphenylmethane.

Examples of the diallylated bisphenol C include 2,2-bis[2-(2-propenyl)-3-methyl-4-hydroxyphenyl]propane, 2,2-bis[2-(2-propenyl)-4-hydroxy-5-methylphenyl]propane, 2,2-bis[3-(2-propenyl)-4-hydroxy-5-methylphenyl]propane, 2-[2-(2-propenyl)-3-methyl-4-hydroxyphenyl]-2-[2-(2-propenyl)-4-hydroxy-5-methylphenyl]propane, 2-[2-(2-propenyl)-3-methyl-4-hydroxyphenyl]-2-[3-(2-propenyl)-4-hydroxy-5-methylphenyl]propane, and 2-[2-(2-propenyl)-4-hydroxy-5-methylphenyl]-2-[3-(2-propenyl)-4-hydroxy-5-methylphenyl]propane.

Examples of the diallylated bisphenol E include 1,1-bis[2-(2-propenyl)-4-hydroxyphenyl]ethane, 1,1-bis[3-(2-propenyl)-4-hydroxyphenyl]ethane, 1-[2-(2-propenyl)-4-hydroxyphenyl]-1-[3-(2-propenyl)-4-hydroxyphenyl]ethane, and 1,1-bis[4-(2-propenyloxy)phenyl]ethane.

Examples of the diallylated bisphenol F include bis[2-(2-propenyl)-4-hydroxyphenyl]methane, bis[3-(2-propenyl)-4-hydroxyphenyl]methane, [2-(2-propenyl)-4-hydroxyphenyl] [3-(2-propenyl)-4-hydroxyphenyl]methane, and bis[4-(2-propenyloxy)phenyl]methane.

The benzene poly(2 to 6) carboxylic acid poly(2 to 6) allyl ester contains 2 to 6 carboxylic acid groups. The number of allyl groups bonded to the carboxylic acid groups is 2 to 6, and the number of the allyl groups is smaller than the number of the carboxylic acid groups.

Examples of the benzene poly(6) carboxylic acid poly(6) allyl ester include mellitic acid hexaallyl ester; examples of the benzene poly(5) carboxylic acid poly(5) allyl ester include benzene pentacarboxylic acid pentaallyl ester; examples of the benzene poly(4) carboxylic acid poly(4) allyl ester include pyromellitic acid tetraallyl ester; examples of the benzene poly(3) carboxylic acid poly(3) allyl ester include trimellitic acid triallyl ester and trimesic acid triallyl ester; and examples of the benzene poly(2) carboxylic acid poly(2) allyl ester include diallyl orthophthalate (structure represented by the following formula (10)), diallyl isophthalate (structure represented by the following formula (11)), and diallyl terephthalate (structure represented by the following formula (12)).

Preferred among these is benzene poly(2) carboxylic acid poly(2) allyl ester (also referred to as diallyl phthalate) such as diallyl orthophthalate, diallyl isophthalate, or diallyl terephthalate.

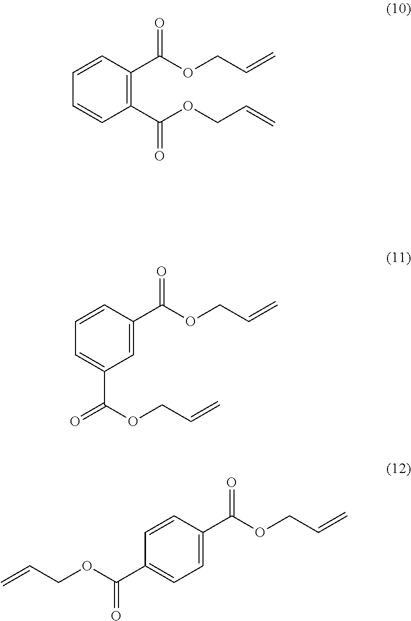 [SMILES: C=CCOC(=O)c1ccccc1C(=O)OCC=C ; C=CCOC(=O)c1cccc(C(=O)OCC=C)c1 ; C=CCOC(=O)c1ccc(C(=O)OCC=C)cc1]

The allylated novolac has a structure represented by the following formula (13).

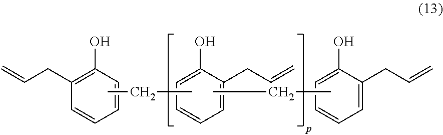

In the formula (13), p is an integer of 1 to 1000.

Preferred among these are diallylated bisphenol A such as 2,2-bis[2-(2-propenyl)-4-hydroxyphenyl]propane, 2,2-bis[3-(2-propenyl)-4-hydroxyphenyl]propane, 2-[2-(2-propenyl)-4-hydroxyphenyl]-2-[3-(2-propenyl)-4-hydroxyphenyl]propane, or 2,2-bis[4-(2-propenyloxy)phenyl]propane; diallyl phthalate such as diallyl orthophthalate, diallyl terephthalate, or diallyl isophthalate; and allylated novolac.

The thermosetting resin composition of the present invention preferably contains the allyl compound (A) in a ratio of 10 to 90 parts by weight, more preferably 15 to 60 parts by weight, still more preferably 20 to 50 parts by weight relative to 100 parts by weight of the maleimide compound (B) in the thermosetting resin composition.

### <Thiol Compound (C)>

The thiol compound (C) in the thermosetting resin composition of the present invention contains at least two or more thiol groups (also referred to as mercapto groups) in a molecule.

The thiol compound (C) may have any structure containing at least two or more thiol groups in a molecule. It preferably has a structure represented by the following formula (14).

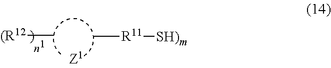

Z¹ represented by the dashed circle is an organic group having a cyclic structure, and may be any of an aromatic group, a heterocycle group, and a polycyclic group. The subscript m is an integer of 2 to 10, and n¹ is an integer of 0 to 8. The subscript m is preferably 2 to 5.

m number of R¹¹s are each independently an organic group selected from the group consisting of chain aliphatic groups, aliphatic groups having a cyclic structure and aromatic groups, or an organic group including a combination of multiple organic groups selected therefrom. R¹¹ may be one in which multiple organic groups having a cyclic structure are bonded to each other through a bond selected from the group consisting of an ester bond, an ether bond, an amide bond, and a urethane bond. n¹ number of R¹²s are each independently one selected from the group consisting of a hydrogen atom, a methyl group, an ethyl group, a propyl group, a fluoro group, a chloro group, a bromo group, and an iodine group.

The thiol compound (C) represented by the formula (14) contains the organic group Z¹ having a cyclic structure, R¹¹ linking the organic group Z¹ to the thiol group, and R¹² bonded to the organic group Z¹.

First, the following describes the organic group Z in the thiol compound (C).

The organic group Z¹ having a cyclic structure may be any of an aromatic group, a heterocyclic group, and a polycyclic group.

Examples of an aromatic group for the organic group Z¹ include those having a structure obtained by removing any number of hydrogen atoms from each structure represented by the following formulas (15) to (18).

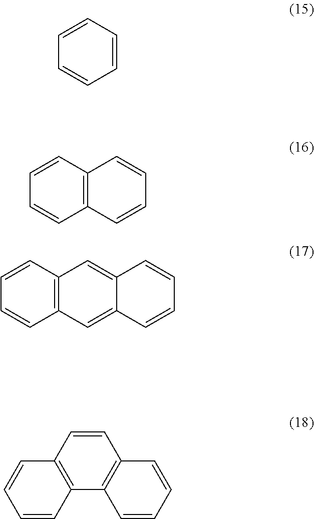

Examples of a heterocyclic group for the organic group Z¹ include those represented by the following formulas (19) and (20).

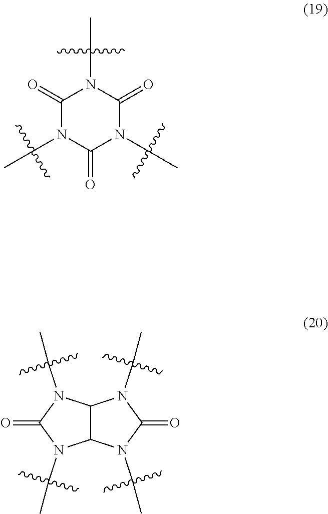 [SMILES: *n1c(=O)n(*)c(=O)n(*)c1=O ; *N1C(=O)N(*)C2C1N(*)C(=O)N2*]

In the case of the organic group Z¹ having a structure represented by the formula (19) or (20), the group (—R¹¹—SH) is preferably bonded to all of the nitrogen atoms in the ring.

In addition to the above structures, examples of a polycyclic ring for the organic group Z¹ include those having a structure represented by the following formulas (21) to (24). Z may be one obtained by removing 2 to 10 hydrogen atoms from a spiro compound.

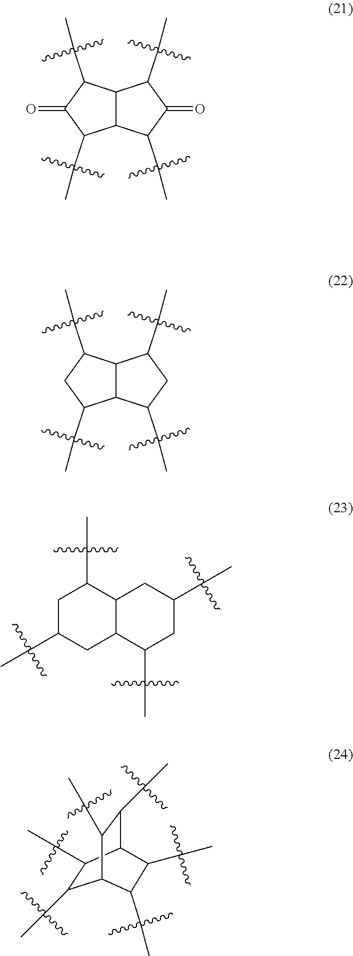 [SMILES: *C1C(=O)C(*)C2C(*)C(=O)C(*)C12 ; *C1CC(*)C2C(*)CC(*)C12 ; *C1CC(*)C2CC(*)CC(*)C2C1 ; *C1C(*)C2C(*)C(*)C1C(*)C2*]

The following describes R in the thiol compound (C).

R¹¹ is preferably a C2-C12 linear alkylene group optionally containing a bond selected from the group consisting of an ester bond, an ether bond, an amide bond, and a urethane bond. Preferably, any of the ester bond, ether bond, amide bond, and urethane bond is not directly bonded to a nitrogen atom on an isocyanurate ring or a sulfur atom of the thiol group.

Examples of the C2-C12 linear alkylene group include ethylene, propylene, butylene, pentylene, hexylene, heptylene, octylene, nonylene, decylene, undecylene, and dodecylene groups. Preferred among these are propylene, butylene, pentylene, hexylene, heptylene, and octylene groups. For easy availability of the raw materials for production, ethylene, propylene, butylene, pentylene, and hexylene groups are more preferred.

When R¹¹ contains a bond such as an ester, ether, amide, or urethane bond, the carbon atom in the ester, amide, or urethane bond is excluded from the number of carbon atoms of the linear alkylene group. For example, in the case where R¹¹ is a C12 linear alkylene group containing one ester bond, the number of carbon atoms of R¹¹ is 13.

Examples of the ester-containing C2-C12 linear alkylene group include 2-oxo-3-oxabutylene (—CH₂—COO—CH₂-), 2-oxa-3-oxobutylene (—CH₂—O—CO—CH₂-), 2-oxo-3-oxapentylene (—CH₂—CO—O—C₂H₄-), 3-oxo-4-oxapentylene (—C₂H₄—COO—CH₂—), 2-oxa-3-oxopentylene (—CH₂—O—CO—C₂H₄-), 3-oxa-4-oxopentylene (—C₂H₄—O—CO—CH₂—), 2-oxo-3-oxahexylene (—CH₂—CO—O-n-C₃H₆-), 3-oxo-4-oxahexylene (—C₂H₄—CO—O—C₂H₄-), 4-oxo-5-oxahexylene (-n-C₃H₆—COO—CH₂—), 2-oxa-3-oxohexylene (—CH₂—O—CO-n-C₃H₆-), 3-oxa-4-oxohexylene (—C₂H₄—O—CO—C₂H₄-), 4-oxa-5-oxohexylene (-n-C₃H₆—O—CO—CH₂—), 2-oxo-3-oxaheptylene (—CH₂—CO—O-n-C₄H—), 3-oxo-4-oxaheptylene (—C₂H₄—CO—O-n-C₃H₆-), 4-oxo-5-oxaheptylene (-n-C₃H₆—CO—O—C₂H₄—), 5-oxo-6-oxaheptylene (-n-C₄H₈—COO—CH₂—), 2-oxa-3-oxoheptylene (—CH₂—O—CO-n-C₄H₈—), 3-oxa-4-oxoheptylene (—C₂H₄—O—CO-n-C₃H₆-), 4-oxa-5-oxoheptylene (-n-C₃H₆—O—CO—C₂H₄—), 5-oxa-6-oxoheptylene (-n-C₄H₈—O—CO—CH₂—), 2-oxo-3-oxaoctylene (—CH₂—CO—O-n-C₅H₁₀-), 3-oxo-4-oxaoctylene (—C₂H₄—CO—O-n-C₄H₈—), 4-oxo-5-oxaoctylene (-n-C₃H₆—CO—O-n-C₃H₆—), 5-oxo-6-oxaoctylene (-n-C₄H₈—CO—O—C₂H₄—), 6-oxo-7-oxaoctylene (-n-C₅H₁₀—COO—CH₂—), 2-oxa-3-oxooctylene (—CH₂—O—CO-n-C₅H₁₀—), 3-oxa-4-oxooctylene (—C₂H₄—O—CO-n-C₄H₈—), 4-oxa-5-oxooctylene (-n-C₃H₆—O—CO-n-C₃H₆—), 5-oxa-6-oxooctylene (-n-C₄H₈—O—CO—C₂H₄—), 6-oxa-7-oxooctylene (-n-C₅H₁₀—O—CO—CH₂—), 2-oxo-3-oxanonylene (—CH₂—CO—O-n-C₆H₁₂-), 3-oxo-4-oxanonylene (—C₂H₄—CO—O-n-C₅H₁₀—), 4-oxo-5-oxanonylene (-n-C₃H₆—CO—O-n-C₄H₈—), 5-oxo-6-oxanonylene (-n-C₄H₈—CO—O-n-C₃H₆—), 6-oxo-7-oxanonylene (-n-C₅H₁₀—CO—O—C₂H₄—), 7-oxo-8-oxanonylene (-n-C₆H₁₂—CO—O—CH₂—), 2-oxa-3-oxononylene (—CH₂—O—CO-n-C₆H₁₂-), 3-oxa-4-oxononylene (—C₂H₄—O—CO-n-C₅H₁₀—), 4-oxa-5-oxononylene (-n-C₃H₆—O—CO-n-C₄H₈—), 5-oxa-6-oxononylene (-n-C₄H₈—O—CO-n-C₃H₆—), 6-oxa-7-oxononylene (-n-C₅H₁₀—O—CO—C₂H₄—), 7-oxa-8-oxononylene (-n-C₆H₁₂—O—CO—CH₂—), 2-oxo-3-oxadecylene (—CH₂—CO—O-n-C₇H₁₄—), 3-oxo-4-oxadecylene (—C₂H₄—CO—O-n-C₆H₁₂—), 4-oxo-5-oxadecylene (-n-C₃H₆—CO—O-n-C₅H₁₀—), 5-oxo-6-oxadecylene (-n-C₄H₈—CO—O-n-C₄H₈—), 6-oxo-7-oxadecylene (-n-C₅H₁₀—CO—O-n-C₃H₆—), 7-oxo-8-oxadecylene (-n-C₆H₁₂—CO—O—C₂H₄—), 8-oxo-9-oxadecylene (-n-C₇H₁₄—COO—CH₂—), 2-oxa-3-oxodecylene (—CH₂—O—CO-n-C₇H₁₄—), 3-oxa-4-oxodecylene (—C₂H₆—O—CO-n-C₆H₁₀—), 4-oxa-5-oxodecylene (-n-C₃H₆—O—CO-n-C₅H₁₀—), 5-oxa-6-oxodecylene (-n-C₄H₈—O—CO-n-C₄H₈—), 6-oxa-7-oxodecylene (-n-C₅H₁₀—O—CO-n-C₃H₆—), 7-oxa-8-oxodecylene (-n-C₆H₁₂—O—CO—C₂H₄—), 8-oxa-9-oxodecylene (-n-C₇H₁₂—O—CO—CH₂—), 2-oxo-3-oxaundecylene (—CH₂—CO—O-n-C₈H₁₆—), 3-oxo-4-oxaundecylene (—C₂H₄—CO—O-n-C₇H₁₄—), 4-oxo-5-oxaundecylene (-n-C₃H₆—CO—O-n-C₆H₁₂—), 5-oxo-6-oxaundecylene (-n-C₄H₈—CO—O-n-C₅H₁₀—), 6-oxo-7-oxaundecylene (-n-C₅H₁₀—CO—O-n-C₄H₈—), 7-oxo-8-oxaundecylene (-n-C₆H₁₂—CO—O-n-C₃H₆—), 8-oxo-9-oxaundecylene (-n-C₇H₁₄—CO—O—C₂H₄—), 9-oxo-10-oxaundecylene (-n-C₈H₁₆—CO—O—CH₂—), 2-oxa-3-oxoundecylene (—CH₂—O—CO-n-C₈H₁₆—), 3-oxa-4-oxoundecylene (—C₂H₄—O—CO-n-C₇H₁₄—), 4-oxa-5-oxoundecylene (-n-C₃H₆—O—CO-n-C₆H₁₂—), 5-oxa-6-oxoundecylene (-n-C₄H₈—O—CO-n-C₅H₁₀—), 6-oxa-7-oxoundecylene (-n-C₅H₁₀—O—CO-n-C₄H₈—), 7-oxa-8-oxoundecylene (-n-C₆H₁₂—O—CO-n-C₃H₆—), 8-oxa-9-oxoundecylene (-n-C₇H₁₄—O—CO—C₂H₄—), 9-oxa-10-oxoundecylene (-n-C₈H₁₆—CO—CH₂—), 2-oxo-3-oxadodecylene (—CH₂—CO—O-n-C₉H₁₈—), 3-oxo-4-oxadodecylene (—C₂H₄—CO—O-n-C₈H₁₆-), 4-oxo-5-oxadodecylene (-n-C₃H₆—CO—O-n-C₇H₁₄-), 5-oxo-6-oxadodecylene (-n-C₄H₈—CO—O-n-C₆H₁₂-), 6-oxo-7-oxadodecylene (-n-C₅H₁₀—CO—O-n-C₅H₁₀—), 7-oxo-8-oxadodecylene (-n-C₆H₁₂—CO—O-n-C₄H₈—), 8-oxo-9-oxadodecylene (-n-C₇H₁₄—CO—O-n-C₃H₆—), 9-oxo-10-oxadodecylene (-n-C₈H₁₆—CO—O—C₂H₄—), 10-oxo-11-oxadodecylene (-n-C₉H₁₈—COO—CH₂—), 2-oxa-3-oxododecylene (—CH₂—O—CO-n-C₉H₁₈—), 3-oxa-4-oxododecylene (—C₂H₄—O—CO-n-C₈H₁₆-), 4-oxa-5-oxododecylene (-n-C₃H₆—O—CO-n-C₇H₁₄-), 5-oxa-6-oxododecylene (-n-C₄H₈—O—CO-n-C₆H₁₂-), 6-oxa-7-oxododecylene (-n-C₅H₁₀—O—CO-n-C₅H₁₀—), 7-oxa-8-oxododecylene (-n-C₆H₁₂—O—CO-n-C₄H₈—), 8-oxa-9-oxododecylene (-n-C₇H₁₄—O—CO-n-C₃H₆—), 9-oxa-10-oxododecylene (-n-C₈H₁₆—O—CO—C₂H₄—), and 10-oxa-11-oxododecylene (-n-C₉H₁₈—O—CO—CH₂—) groups.

Preferred among these ester-containing C2-C12 linear alkylene groups are 2-oxa-3-oxopentylene, 3-oxa-4-oxopentylene, 2-oxa-3-oxohexylene, 3-oxa-4-oxohexylene, 2-oxa-3-oxoheptylene, 3-oxa-4-oxoheptylene, 2-oxa-3-oxooctylene, and 3-oxa-4-oxooctylene groups. For easy availability of the raw materials for production, a 3-oxa-4-oxohexylene group and a 3-oxa-4-oxoheptylene group are more preferable.

The ether-containing C2-C12 linear alkylene group corresponds to a group obtained by changing the carbonyl group in the ester-containing C2-C12 linear alkylene group with a methylene group. Examples thereof include 2-oxapropylene, 2-oxabutylene, 3-oxabutylene, 2-oxapentylene, 3-oxapentylene, 4-oxapentylene, 2-oxahexylene, 3-oxahexylene, 4-oxahexylene, 5-oxahexylene, 2-oxaheptylene, 3-oxaheptylene, 4-oxaheptylene, 5-oxaheptylene, 6-oxaheptylene, 2-oxaoctylene, 3-oxaoctylene, 4-oxaoctylene, 5-oxaoctylene, 6-oxaoctylene, 7-oxaoctylene, 2-oxanonylene, 3-oxanonylene, 4-oxanonylene, 5-oxanonylene, 6-oxanonylene, 7-oxanonylene, 8-oxanonylene, 2-oxadecylene, 3-oxadecylene, 4-oxadecylene, 5-oxadecylene, 6-oxadecylene, 7-oxadecylene, 8-oxadecylene, 9-oxadecylene, 2-oxaundecylene, 3-oxaundecylene, 4-oxaundecylene, 5-oxaundecylene, 6-oxaundecylene, 7-oxaundecylene, 8-oxaundecylene, 9-oxaundecylene, 10-oxaundecylene, 2-oxadodecylene, 3-oxadodecylene, 4-oxadodecylene, 5-oxadodecylene, 6-oxadodecylene, 7-oxadodecylene, 8-oxadodecylene, 9-oxadodecylene, 10-oxadodecylene, and 11-oxadodecylene groups.

Preferred among these ether-containing C2-C12 linear alkylene groups are 2-oxapropylene, 2-oxabutylene, and 2-oxapentylene groups. For easy availability of the raw materials for production, a 2-oxabutylene group is more preferable.

The amide-containing C2-C12 linear alkylene group corresponds to a group obtained by changing the ether group (the site represented by “oxa” in each of the listed substituents) in the ester-containing C2-C12 linear alkylene group with an azamethylene group. Examples thereof include 2-oxo-3-azabutylene (—CH₂—CO—NH—CH₂—), 2-aza-3-oxobutylene (—CH₂—NH—CO—CH₂—), 2-oxo-3-azapentylene (—CH₂—CO—NH—C₂H₄—), 3-oxo-4-azapentylene (—C₂H₄—CO—NH—CH₂—), 2-aza-3-oxopentylene (—CH₂—NH—CO—C₂H₄—), 3-aza-4-oxopentylene (—C₂H₄—NH—CO—CH₂—), 2-oxo-3-azahexylene (—CH₂—CO—NH-n-C₃H₆—), 3-oxo-4-azahexylene (—C₂H₄—CO—NH—C₂H₄—), 4-oxo-5-azahexylene (-n-C₃H₆—CO—NH—CH₂—), 2-aza-3-oxohexylene (—CH₂—NH—CO-n-C₃H₆—), 3-aza-4-oxohexylene (—C₂H₄—NH—CO—C₂H₄—), 4-aza-5-oxohexylene (-n-C₃H₆—NH—CO—CH₂—), 2-oxo-3-azaheptylene (—CH₂—CO—NH-n-C₄H₈—), 3-oxo-4-azaheptylene (—C₂H₄—CO—NH-n-C₃H₆—), 4-oxo-5-azaheptylene (-n-C₃H₆—CO—NH—C₂H₄—), 5-oxo-6-azaheptylene (-n-C₄H₈—CO—NH—CH₂—), 2-aza-3-oxoheptylene (—CH₂—NH—CO-n-C₄H₈—), 3-aza-4-oxoheptylene (—C₂H₄—NH—CO-n-C₃H₆—), 4-aza-5-oxoheptylene (-n-C₃H₆—NH—CO—C₂H₄—), 5-aza-6-oxoheptylene (-n-C₄H₈—NH—CO—CH₂—), 2-oxo-3-azaoctylene (—CH₂—CO—NH-n-C₅H₁₀—), 3-oxo-4-azaoctylene (—C₂H₄—CO—NH-n-C₄H₈—), 4-oxo-5-azaoctylene (-n-C₃H₆—CO—NH-n-C₃H₆—), 5-oxo-6-azaoctylene (-n-C₄H₈—CO—NH—C₂H₄—), 6-oxo-7-azaoctylene (-n-C₅H₁₀—CO—NH—CH₂—), 2-aza-3-oxooctylene (—CH₂—NH—CO-n-C₅H₁₀—), 3-aza-4-oxooctylene (—C₂H₄—NH—CO-n-C₄H₈—), 4-aza-5-oxooctylene (-n-C₃H₆—NH—CO-n-C₃H₆—), 5-aza-6-oxooctylene (-n-C₄H₈—NH—CO—C₂H₄—), 6-aza-7-oxooctylene (-n-C₅H₁₀—NH—CO—CH₂—), 2-oxo-3-azanonylene (—CH₂—CO—NH-n-C₆H₁₂—), 3-oxo-4-azanonylene (—C₂H₄—CO—NH-n-C₅H₁₀—), 4-oxo-5-azanonylene (-n-C₃H₆—CO—NH-n-C₄H₈—), 5-oxo-6-azanonylene (-n-C₄H₈—CO—NH-n-C₃H₆—), 6-oxo-7-azanonylene (-n-C₅H₁₀—CO—NH—C₂H₄—), 7-oxo-8-azanonylene (-n-C₆H₁₂—CO—NH—CH₂—), 2-aza-3-oxononylene (—CH₂—NH—CO-n-C₆H₁₂—), 3-aza-4-oxononylene (—C₂H₄—NH—CO-n-C₅H₁₀—), 4-aza-5-oxononylene (-n-C₃H₆—NH—CO-n-C₄H₈—), 5-aza-6-oxononylene (-n-C₄H₈—NH—CO-n-C₃H₆—), 6-aza-7-oxononylene (-n-C₅H₁₀—NH—CO—C₂H₄—), 7-aza-8-oxononylene (-n-C₆H₁₂—NH—CO—CH₂—), 2-oxo-3-azadecylene (—CH₂—CO—NH-n-C₇H₁₄—), 3-oxo-4-azadecylene (—C₂H₄—CO—NH-n-C₆H₁₂—), 4-oxo-5-azadecylene (-n-C₃H₆—CO—NH-n-C₅H₁₀—), 5-oxo-6-azadecylene (-n-C₄H₈—CO—NH-n-C₄H₈—), 6-oxo-7-azadecylene (-n-C₅H₁₀—CO—NH-n-C₃H₆—), 7-oxo-8-azadecylene (-n-C₆H₁₂—CO—NH—C₂H₄—), 8-oxo-9-azadecylene (-n-C₇H₁₄—CO—NH—CH₂—), 2-aza-3-oxodecylene (—CH₂—NH—CO-n-C₇H₁₄—), 3-aza-4-oxodecylene (—C₂H₄—NH—CO-n-C₆H₁₂—), 4-aza-5-oxodecylene (-n-C₃H₆—NH—CO-n-C₅H₁₀—), 5-aza-6-oxodecylene (-n-C₄H₈—NH—CO-n-C₄H₈—), 6-aza-7-oxodecylene (-n-C₅H₁₀—NH—CO-n-C₃H₆—), 7-aza-8-oxodecylene (-n-C₆H₁₂—NH—CO—C₂H₄—), 8-aza-9-oxodecylene (-n-C₇H₁₄—NH—CO—CH₂—), 2-oxo-3-azaundecylene (—CH₂—CO—NH-n-C₈H₁₆—), 3-oxo-4-azaundecylene (—C₂H₄—CO—NH-n-C₇H₁₄—), 4-oxo-5-azaundecylene (-n-C₃H₆—CO—NH-n-C₆H₁₂—), 5-oxo-6-azaundecylene (-n-C₄H₈—CO—NH-n-C₅H₁₀—), 6-oxo-7-azaundecylene (-n-C₅H₁₀—CO—NH-n-C₄H₈—), 7-oxo-8-azaundecylene (-n-C₆H₁₂—CO—NH-n-C₃H₆—), 8-oxo-9-azaundecylene (-n-C₇H₁₄—CO—NH—C₂H₄—), 9-oxo-10-azaundecylene (-n-C₈H₁₆—CO—NH—CH₂—), 2-aza-3-oxoundecylene (—CH₂—NH—CO-n-C₈H₁₆—), 3-aza-4-oxoundecylene (—C₂H₄—NH—CO-n-C₇H₁₄—), 4-aza-5-oxoundecylene (-n-C₃H₆—NH—CO-n-C₆H₁₂—), 5-aza-6-oxoundecylene (-n-C₄H₈—NH—CO-n-C₅H₁₀—), 6-aza-7-oxoundecylene (-n-C₅H₁₀—NH—CO-n-C₄H₈—), 7-aza-8-oxoundecylene (-n-C₆H₁₂—NH—CO-n-C₃H₆—), 8-aza-9-oxoundecylene (-n-C₇H₁₄—NH—CO—C₂H₄—), 9-aza-10-oxoundecylene (-n-C₈H₁₆—NH—CO—CH₂—), 2-oxo-3-azadodecylene (—CH₂—CO—NH-n-C₉H₁₈—), 3-oxo-4-azadodecylene (—C₂H₄—CO—NH-n-C₈H₁₆—), 4-oxo-5-azadodecylene (-n-C₃H₆—CO—NH-n-C₇H₁₄—), 5-oxo-6-azadodecylene (-n-C₄H₈—CO—NH-n-C₆H₁₂—), 6-oxo-7-azadodecylene (-n-C₅H₁₀—CO—NH-n-C₅H₁₀—), 7-oxo-8-azadodecylene (-n-C₆H₁₂—CO—NH-n-C₄H₈—), 8-oxo-9-azadodecylene (-n-C₇H₁₄—CO—NH-n-C₃H₆—), 9-oxo-10-azadodecylene (-n-C₈H₁₆—CO—NH—C₂H₄—), 10-oxo-11-azadodecylene (-n-C₉H₁₈—CO—NH—CH₂—), 2-aza-3-oxododecylene (—CH₂—NH—CO-n-C₉H₁₈—), 3-aza-4-oxododecylene (—C₂H₄—NH—CO-n-C₈H₁₆—), 4-aza-5-oxododecylene (-n-C₃H₆—NH—CO-n-C₇H₁₄—), 5-aza-6-oxododecylene (-n-C₄H₈—NH—CO-n-C₆H₁₂—), 6-aza-7-oxododecylene (-n-C₅H₁₀—NH—CO-n-C₅H₁₀—), 7-aza-8-oxododecylene (-n-C₆H₁₂—NH—CO-n-C₄H₈—), 8-aza-9-oxododecylene (-n-C₇H₁₄—NH—CO-n-C₃H₆—), 9-aza-10-oxododecylene (-n-C₈H₁₆—NH—CO—C₂H₄—), and 10-aza-11-oxododecylene (-n-C₉H₁₈—NH—CO—CH₂—) groups.

Preferred among these amide-containing C2-C12 linear alkylene groups are 2-aza-3-oxobutylene, 2-aza-3-oxopentylene, 3-aza-4-oxopentylene, and 3-aza-4-oxohexylene groups. For easy availability of the raw materials for production, a 3-aza-4-oxohexylene group is more preferable.

The urethane-containing C2-C12 linear alkylene group corresponds to a group obtained by changing the methylene group that attaches to the carbonyl group (the site represented by “oxo” in each of the listed substituents) of the ester-containing C2-C12 linear alkylene group with an azamethylene group. Examples thereof include 2-oxa-3-oxo-4-azapentylene (—CH₂—O—CO—NH—CH₂—), 2-aza-3-oxo-4-oxapentylene (—CH₂—NH—COO—CH₂—), 2-oxa-3-oxo-4-azahexylene (—CH₂—O—CO—NH—C₂H₄—), 3-oxa-4-oxo-5-azahexylene (—C₂H₄—O—CO—NH—CH₂—), 2-aza-3-oxo-4-oxahexylene (—CH₂—NH—CO—O—C₂H₄—), 3-aza-4-oxo-5-oxahexylene (—C₂H₄—NH—COO—CH₂—), 2-oxa-3-oxo-4-azaheptylene (—CH₂—O—CO—NH-n-C₃H₆—), 3-oxa-4-oxo-5-azaheptylene (—C₂H₄—O—CO—NH—C₂H₄—), 4-oxa-5-oxo-6-azaheptylene (-n-C₃H₆—O—CO—NH—CH₂—), 2-aza-3-oxo-4-oxaheptylene (—CH₂—NH—CO—O-n-C₃H₆—), 3-aza-4-oxo-5-oxaheptylene (—C₂H₄—NH—CO—O—C₂H₄—), 4-aza-5-oxo-6-oxaheptylene (-n-C₃H₆—NH—COO—CH₂—), 2-oxa-3-oxo-4-azaoctylene (—CH₂—O—CO—NH-n-C₄H₈—), 3-oxa-4-oxo-5-azaoctylene (—C₂H₄—O—CO—NH-n-C₃H₆—), 4-oxa-5-oxo-6-azaoctylene (-n-C₃H₆—O—CO—NH—C₂H₄—), 5-oxa-6-oxo-7-azaoctylene (-n-C₄H₈—O—CO—NH—CH₂—), 2-aza-3-oxo-4-oxaoctylene (—CH₂—NH—CO—O-n-C₄H₈—), 3-aza-4-oxo-5-oxaoctylene (—C₂H₄—NH—CO—O-n-C₃H₆—), 4-aza-5-oxo-6-oxaoctylene (-n-C₃H₆—NH—CO—O—C₂H₄—), 5-aza-6-oxo-7-oxaoctylene (-n-C₄H₈—NH—COO—CH₂—), 2-oxa-3-oxo-4-azanonylene (—CH₂—O—CO—NH-n-C₅H₁₀—), 3-oxa-4-oxo-5-azanonylene (—C₂H₄—O—CO—NH-n-C₄H₈—), 4-oxa-5-oxo-6-azanonylene (-n-C₃H₆—O—CO—NH-n-C₃H₆—), 5-oxa-6-oxo-7-azanonylene (-n-C₄H₈—O—CO—NH—C₂H₄—), 6-oxa-7-oxo-8-azanonylene (-n-C₅H₁₀—O—CO—NH—CH₂—), 2-aza-3-oxo-4-oxanonylene (—CH₂—NH—CO—O-n-C₅H₁₀—), 3-aza-4-oxo-5-oxanonylene (—C₂H₄—NH—CO—O-n-C₄H₈—), 4-aza-5-oxo-6-oxanonylene (-n-C₃H₆—NH—CO—O-n-C₃H₆—), 5-aza-6-oxo-7-oxanonylene (-n-C₄H₈—NH—CO—O—C₂H₄—), 6-aza-7-oxo-8-oxanonylene (-n-C₅H₁₀—NH—COO—CH₂—), 2-oxa-3-oxo-4-azadecylene (—CH₂—O—CO—NH-n-C₆H₁₂—), 3-oxa-4-oxo-5-azadecylene (—C₂H₄—O—CO—NH-n-C₅H₁₀—), 4-oxa-5-oxo-6-azadecylene (-n-C₃H₆—O—CO—NH-n-C₄H₈—), 5-oxa-6-oxo-7-azadecylene (-n-C₄H₈—O—CO—NH-n-C₃H₆—), 6-oxa-7-oxo-8-azadecylene (-n-C₅H₁₀—O—CO—NH—C₂H₄—), 7-oxa-8-oxo-9-azadecylene (-n-C₆H₁₂—O—CO—NH—CH₂—), 2-aza-3-oxo-4-oxadecylene (—CH₂—NH—CO—O-n-C₆H₁₂—), 3-aza-4-oxo-5-oxadecylene (—C₂H₄—NH—CO—O-n-C₅H₁₀—), 4-aza-5-oxo-6-oxadecylene (-n-C₃H₆—NH—CO—O-n-C₄H₈—), 5-aza-6-oxo-7-oxadecylene (-n-C₄H₈—NH—CO—O-n-C₃H₆—), 6-aza-7-oxo-8-oxadecylene (-n-C₅H₁₀—NH—CO—O—C₂H₄—), 7-aza-8-oxo-9-oxadecylene (-n-C₆H₁₂—NH—COO—CH₂—), 2-aza-3-oxo-4-oxaundecylene (—CH₂—NH—CO—O-n-C₇H₁₄—), 3-aza-4-oxo-5-oxaundecylene (—C₂H₄—NH—CO—O-n-C₆H₁₂—), 4-aza-5-oxo-6-oxaundecylene (-n-C₃H₆—NH—CO—O-n-C₅H₁₀—), 5-aza-6-oxo-7-oxaundecylene (-n-C₄H₈—NH—CO—O-n-C₄H₈—), 6-aza-7-oxo-8-oxaundecylene (-n-C₅H₁₀—NH—CO—O-n-C₃H₆—), 7-aza-8-oxo-9-oxaundecylene (-n-C₆H₁₂—NH—CO—O—C₂H₄—), 8-aza-9-oxo-10-oxaundecylene (-n-C₇H₁₄—NH—COO—CH₂—), 2-oxa-3-oxo-4-azaundecylene (—CH₂—O—CO—NH-n-C₇H₁₄—), 3-oxa-4-oxo-5-azaundecylene (—C₂H₄—O—CO—NH-n-C₆H₁₂—), 4-oxa-5-oxo-6-azaundecylene (-n-C₃H₆—O—CO—NH-n-C₅H₁₀—), 5-oxa-6-oxo-7-azaundecylene (-n-C₄H₈—O—CO—NH-n-C₄H₈—), 6-oxa-7-oxo-8-azaundecylene (-n-C₅H₁₀—O—CO—NH-n-C₃H₆—), 7-oxa-8-oxo-9-azaundecylene (-n-C₆H₁₂—O—CO—NH—C₂H₄—), 8-oxa-9-oxo-10-azaundecylene (-n-C₇H₁₄—O—CO—NH—CH₂—), 2-aza-3-oxo-4-oxadodecylene (—CH₂—NH—CO—O-n-C₈H₁₆—), 3-aza-4-oxo-5-oxadodecylene (—C₂H₄—NH—CO—O-n-C₇H₁₄—), 4-aza-5-oxo-6-oxadodecylene (-n-C₃H₆—NH—CO—O-n-C₆H₁₂—), 5-aza-6-oxo-7-oxadodecylene (-n-C₄H₈—NH—CO—O-n-C₅H₁₀—), 6-aza-7-oxo-8-oxadodecylene (-n-C₅H₁—NH—CO—O-n-C₄H₈—), 7-aza-8-oxo-9-oxadodecylene (-n-C₆H₁₂—NH—CO—O-n-C₃H₆—), 8-aza-9-oxo-10-oxadodecylene (-n-C₇H₁₄—NH—CO—O—C₂H₄—), 9-aza-10-oxo-11-oxadodecylene (-n-C₈H₁₆—NH—COO—CH₂—), 2-oxa-3-oxo-4-azadodecylene (—CH₂—O—CO—NH-n-C₈H₁₆—), 3-oxa-4-oxo-5-azadodecylene (—C₂H₄—O—CO—NH-n-C₇H₁₄—), 4-oxa-5-oxo-6-azadodecylene (-n-C₃H₆—O—CO—NH-n-C₆H₁₂—), 5-oxa-6-oxo-7-azadodecylene (-n-C₄H₈—O—CO—NH-n-C₅H₁₀—), 6-oxa-7-oxo-8-azadodecylene (-n-C₅H₁₀—O—CO—NH-n-C₄H₈—), 7-oxa-8-oxo-9-azadodecylene (-n-C₆H₁₂—O—CO—NH-n-C₃H₆—), 8-oxa-9-oxo-10-azadodecylene (-n-C₇H₁₄—O—CO—NH—C₂H₄—), and 9-oxa-10-oxo-11-azadodecylene (-n-C₈H₁₆—O—CO—NH—CH₂—).

In R¹¹, the carbon to be bonded to Z¹ is counted as the first carbon. Each of the above substituents forms a bond at its left side with Z¹.

A compound having the structure represented by the formula (14) is exemplified by tris-[(3-mercaptopropionyloxy)-ethyl]-isocyanurate, 1,3,5-tris(mercaptomethyl)benzene, 1,3-bis(mercaptomethyl)benzene, 1,4-bis(mercaptomethyl)benzene, and 1,3,4,6-tetrakis(mercaptoethyl)glycoluril.

In addition to the compounds having a structure represented by the formula (14), the thiol compound (C) may be, for example, a compound having a structure represented by the following formula (25).

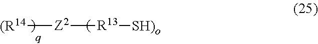

The subscript o is an integer of 2 to 6, q is an integer of 0 to 4, and o+q is an integer of 2 to 6. Z² is a C1-C6 organic group, and may contain a bond selected from the group consisting of an ester bond, an ether bond, an amide bond, and a urethane bond. o number of R¹³s are each independently an organic group selected from the group consisting of chain aliphatic groups, aliphatic groups having a cyclic structure and aromatic groups, or an organic group including a combination of multiple organic groups selected therefrom. R¹³ may contain one or more groups and/or bonds selected from the group consisting of a carbonyl group, an ether bond, an amide bond, and a urethane bond. q number of R¹⁴s are each independently one selected from the group consisting of a hydrogen atom, a methyl group, an ethyl group, a propyl group, a fluoro group, a chloro group, a bromo group, and an iodine group.

The subscript o is an integer of 2 to 6. A compound having a higher thiol content can be expected to provide a cured resin having enhanced heat resistance. However, considering the balance between the heat resistance and the mechanical properties such as bending strength and toughness, o is preferably 2 to 4.

R¹³ may be suitably any of the substituents for R¹¹ described above.

In R¹³, the carbon to be bonded to Z² is counted as the first carbon.

Z² is preferably a C1-C4 linear alkylene group. Z² may contain a bond selected from the group consisting of an ester bond, an ether bond, an amide bond, and a urethane bond. For easy availability of the raw materials for production, ether bond is preferable among these.

R¹ is preferably a 2-oxa-3-oxopentylene, 2-oxa-3-oxohexylene, 2-oxa-3-oxoheptylene, 2-oxa-3-oxooctylene, 3-oxa-4-oxohexylene, 3-oxa-4-oxoheptylene, or 3-oxa-4-oxooctylene group, or a group represented by —O—(CH₂)₂—O—CO—(CH₂)₂—. For easy availability of the raw materials for production, more preferred are a 2-oxa-3-oxopentylene group, a 2-oxa-3-oxohexylene group, and a group represented by —O—(CH₂)₂—O—CO—(CH₂)₂—.

Z² containing an ether bond more preferably has a structure obtained by removing six hydroxymethyl groups (—CH₂—OH) from dipentaerythritol (structure represented by the following formula (26)).

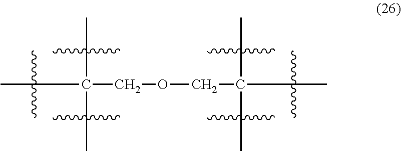 [SMILES: *C(*)(*)COCC(*)(*)*]

A compound having the structure represented by the formula (26) is exemplified by trimethylolpropane tris(3-mercaptopropionate), pentaerythritol tetrakis(3-mercaptopropionate), tetraethylene glycol bis(3-mercaptopropionate), and dipentaerythritol hexakis(3-mercaptopropionate).

The thermosetting resin composition of the present invention preferably contains the thiol compound (C) in a ratio of 1 to 70 parts by weight, more preferably 3 to 40 parts by weight, still more preferably 5 to 20 parts by weight relative to 100 parts by weight of the maleimide compound (B) in the thermosetting resin composition.

The thermosetting resin composition of the present invention may further contain a different component other than the allyl compound (A), the maleimide compound (B), the thiol compound (C), and the cyclic compound (D).

Examples of the different component include an inorganic filler (E), a flame retardant compound (F), and an additive (G). In particular, the thermosetting resin composition containing the inorganic filler (E) can provide a cured resin having a reduced thermal expansion and an improved thermal conductivity with no decrease in heat resistance. Thus, such a thermosetting resin composition can be suitably used as a semiconductor sealing material.

Examples of the additive (G) include ultraviolet absorbers, antioxidants, photopolymerization initiators, fluorescent brightening agents, photosensitizers, dyes, pigments, thickeners, lubricants, defoamers, leveling agents, brighteners, and antistatic agents. A mixture of two or more of these may be used.

Examples of the inorganic filler (E) include natural silica, calcined silica, synthetic silica, amorphous silica, white carbon, alumina, aluminum hydroxide, magnesium hydroxide, calcium silicate, calcium carbonate, zinc borate, zinc stannate, titanium oxide, zinc oxide, molybdenum oxide, zinc molybdate, natural mica, synthetic mica, aerosil, kaolin, clay, talc, calcined kaolin, calcined clay, calcined talc, wollastonite, glass short fiber, glass fine powder, hollow glass, and potassium titanate fiber.

Examples of the flame retardant compound (F) include flame retardants including chlorinated paraffins; phosphorus flame retardants such as phosphates, condensed phosphates, phosphoric acid amides, phosphoric acid amide esters, phosphinates, phosphinate salts, ammonium phosphate, and red phosphorus; nitrogen flame retardants such as melamine, melamine cyanurate, melam, melem, melon, and succinoguanamine; silicone flame retardants; and bromine flame retardants, and flame retardant aids such as antimony trioxide. Each flame retardant compound (F) may be used in any amount that does not inhibit the properties of the thermosetting resin composition of the present invention.

The inorganic filler (E) may be present in any amount. The amount is preferably 90 parts by weight or less based on 100 parts by weight of solids in the whole thermosetting resin composition.

The thermosetting resin composition of the present invention may further contain a thermoplastic resin and/or a thermosetting resin other than the maleimide compound (B).

Examples of the thermoplastic resin include polyolefin resin, polystyrene resin, thermoplastic polyamide resin, polyester resin, polyacetal resin, polycarbonate resin, (meth)acrylic resin, polyarylate resin, polyphenylene ether resin, polyimide resin, polyether nitrile resin, phenoxy resin, polyphenylene sulfide resin, polysulfone resin, polyketone resin, polyether ketone resin, thermoplastic urethane resin, fluorine resin, and thermoplastic polybenzimidazole resin.

Examples of the thermosetting resin other than the maleimide compound (B) include epoxy resin, vinyl ester resin, unsaturated polyester resin, diallyl phthalate resin, phenol resin, cyanate resin, benzoxazine resin, and dicyclopentadiene resin.

These resins may be mixed after the completion of mixing the components (A) to (D) and the other component but before polymerization reaction or may be mixed with the thermosetting resin composition of the present invention that has been partially polymerized by heat or photochemical reaction as described later.

In particular, when the thermosetting resin in the present invention is partially reacted by heat or photochemical reaction to produce an oligomer, the cured thermosetting resin which is cured after mixing the thermosetting resin containing the oligomer with an epoxy resin and an aromatic diamine compound has excellent bending properties. Thus, in a preferred embodiment of the present invention, the thermosetting resin composition of the present invention contains an epoxy resin and an aromatic diamine compound.

The epoxy resin may have any molecular weight or molecular structure as long as it has two or more epoxy groups in a molecule. Specific examples thereof include biphenyl aralkyl-type epoxy resin, biphenyl-type epoxy resin, bisphenol-type epoxy resin, stilbene-type epoxy resin, phenol novolac-type epoxy resin, cresol novolac-type epoxy resin, triphenolmethane-type epoxy resin, alkyl-modified triphenolmethane-type epoxy resin, dihydroxy naphthalene-type epoxy resin, dicyclopentadiene-modified phenol-type epoxy resin, triazine nucleus-containing epoxy resin such as triglycidyl isocyanurate, and alicyclic epoxy resin. These epoxy resins may be used alone or in combination of two or more thereof.

When the thermosetting resin composition of the present invention is thermally cured alone or when the thermosetting resin in the present invention is mixed with the thermoplastic resin and/or the thermosetting resin other than the maleimide compound (B) and the mixture is thermally cured, the composition may contain a curing agent. In a preferred embodiment of the thermosetting resin composition of the present invention, the thermosetting resin composition contains a curing agent.

Examples of the curing agent include chain aliphatic amines such as ethylenediamine, cyclic aliphatic amines such as isophoronediamine; aromatic diamines such as an aromatic diamine compound in which a heteroatom is present at a linking site (e.g., diaminodiphenylsulfone) and an aromatic diamine compound in which a linking site includes an alkyl group (e.g., diaminodiphenylmethane); acid anhydride compounds such as phthalic anhydride; amide compounds such as dicyandiamide; phenol resins, and carboxylic acid compounds.

As described above, when the thermosetting resin composition of the present invention contains an epoxy resin as the thermosetting resin other than the maleimide compound (B), it is preferable that the thermosetting resin composition of the present invention contains an aromatic diamine compound among the above curing agents.

The aromatic diamine compound may have any molecular weight or molecular structure as long as it is an aromatic compound containing two or more amine groups in a molecule. The above-mentioned specific examples of the aromatic diamine compound may be used alone or two or more of these may be used.

The curing agent may be used in any amount that enables reaction between the curing agent and the reactive functional group in the thermosetting resin composition. For example, when the thermosetting resin composition of the present invention contains an epoxy resin and an aromatic diamine compound, the amount of the aromatic diamine compound is such that the equivalent of the amine group is preferably 0.7 times or more and 1.3 times or less, more preferably 0.8 times or more and 1.2 times or less the sum of the equivalent of the epoxy group in the epoxy resin and the equivalent of the maleimide group in the thermosetting resin composition of the present invention.

When the thermosetting resin composition of the present invention contains the thermosetting resin other than the maleimide compound (B), the sum of the weights of the components (A), (B), (C), and (D) is preferably 10 parts by weight or more and 80 parts by weight or less relative to 100 parts by weight of the thermosetting resin other than the maleimide compound (B). The thermosetting resin composition of the present invention containing an epoxy resin as the thermosetting resin other than the maleimide compound (B) can provide a thermosetting resin having particularly excellent bending properties when the thermosetting resin in the present invention is partially reacted by heat or photochemical reaction to produce an oligomer, the oligomer is mixed with an epoxy resin such that the sum of the weights of the components (A), (B), (C), and (D) relative to the weight of the epoxy resin falls within the above range, and the mixture is cured. The sum of the weights of the components (A), (B), (C), and (D) relative to 100 parts by weight of the thermosetting resin other than the maleimide compound (B) is more preferably 20 parts by weight or more and 60 parts by weight or less, still more preferably 30 parts by weight or more and 50 parts by weight or less.

When the thermosetting resin composition of the present invention is thermally cured, it may contain a curing catalyst. Examples thereof include organic metal salts such as zinc octylate and zinc naphthenate; phenol compounds such as phenol and cresol; alcohols such as 1-butanol and 2-ethyl hexanol; imidazoles such as 2-methylimidazole and 2-ethyl-4-methylimidazole, and derivertives such as carboxylic acids of these imidazoles, and adducts of acid anhydrides thereof; amines such as dicyandiamide, benzyldimethylamine, and 4-methyl-N,N-dimethylbenzylamine; phosphorus compounds such as phosphine compounds, phosphine oxide compounds, phosphonium salt compounds, and diphosphine compounds; peroxides such as epoxy-imidazole adduct compounds and di-t-butyl peroxide; and azo compounds such as azobisisobutyronitrile. These curing catalysts may be used alone or two or more of these may be used in combination.

### 2. Manufacturing Method for Thermosetting Resin Composition

The following describes a manufacturing method for a thermosetting resin composition of the present invention.

A manufacturing method for a thermosetting resin composition of the present invention includes mixing an allyl compound (A) containing at least two or more allyl groups and one or more benzene rings in a molecule, a maleimide compound (B) containing at least two or more maleimide groups in a molecule, a thiol compound (C) containing at least two or more thiol groups in a molecule, and a cyclic compound (D) containing at least two or more hydroxyl groups in a molecule.

The above-described mixing of such four components enables production of a thermosetting resin composition which has excellent handleability and which provides a cured product, i.e., a thermosetting resin, having excellent toughness and heat resistance.

In the mixing in the manufacturing method for a thermosetting resin composition of the present invention, the four components may be mixed in any order as long as the four components are mixed. Preferably, the mixing is either a step of mixing the allyl compound (A) and the cyclic compound (D) to obtain a mixture, followed by mixing the thiol compound (C) and the maleimide compound (B) in the stated order with the mixture or a step of mixing the maleimide compound (B) and the cyclic compound (D) to obtain a mixture, followed by mixing the allyl compound (A) and the thiol compound (C) in the stated order with the mixture.

When the four components are mixed in either of these mixing orders, the thermosetting resin obtained by curing the thermosetting resin composition has higher heat resistance.

More preferred is a step of mixing the allyl compound (A) and the cyclic compound (D) to obtain a mixture, followed by mixing the thiol compound (C) and the maleimide compound (B) in the stated order with the mixture. When the four components are mixed in the stated order, the thermosetting resin obtained by curing the thermosetting resin composition has much higher heat resistance.

In the mixing, the “mixing the thiol compound (C) and the maleimide compound (B) in the stated order” means that the addition of the thiol compound (C) is started before the addition of the maleimide compound (B), but does not mean that the addition of the maleimide compound (B) is started after the completion of the addition of the thiol compound (C). Thus, the addition of the maleimide compound (B) may be started before the completion of the addition of the thiol compound (C). Preferably, the addition of the maleimide compound (B) is started after the completion of the addition of the thiol compound (C).

The “mixing the allyl compound (A) and the thiol compound (C) in the stated order” means the same as above, and the addition of the thiol compound (C) may be started before the completion of the addition of the allyl compound (A) as long as the addition of the allyl compound (A) is started before the addition of the thiol compound (C). Preferably, the addition of the thiol compound (C) is started after the completion of the addition of the allyl compound (A).

In the mixing of the allyl compound (A) and the cyclic compound (D), the mixing may be performed by any method. Stirrers may be used, such as a stirrer having a stirring blade (e.g., a paddle-type stirrer, a propeller-type stirrer, an anchor-type stirrer) and a planetary stirrer having a rotating shaft.

In the mixing of the allyl compound (A) and the cyclic compound (D), the mixing may be performed at any temperature. The temperature is preferably 10° C. to 100° C. To enhance uniform dispersibility of the cyclic compound (D), the cyclic compound (D) is preferably dissolved in the allyl compound (A). From that point of view, the temperature is more preferably 40° C. to 100° C.

In the step of mixing the allyl compound (A) and the cyclic compound (D) to obtain a mixture, followed by mixing the thiol compound (C) and the maleimide compound (B) in the stated order with the mixture, the mixing may be performed by any method. Mixing means may be performed, such as a tumbler mixer, a ribbon mixer, a rotary mixer, a Henschel mixer, a Banbury mixer, a roller, a Brabender, a single-screw extruder, a multi-screw extruder, a ruder, and a kneader.

In the step of mixing the allyl compound (A) and the cyclic compound (D) to obtain a mixture, followed by mixing the thiol compound (C) and the maleimide compound (B) in the stated order with the mixture, the mixing may be performed at any temperature. The temperature is preferably 10° C. to 120° C. In consideration of the uniform dispersibility of each component, the temperature is preferably 40° C. or higher, while from the viewpoint of suppressing a side reaction during mixing, the temperature is preferably 100° C. or lower. In other words, the temperature is more preferably 40° C. to 100° C.

In the mixing of the maleimide compound (B) and the cyclic compound (D), the mixing may be performed by any method. Mixers may be used, such as a tumbler mixer, a V-type mixer, and a Henschel mixer.

In the mixing of the maleimide compound (B) and the cyclic compound (D), the mixing may be performed at any temperature. The temperature is preferably 10° C. to 100° C.

In the step of mixing the maleimide compound (B) and the cyclic compound (D) to obtain a mixture, followed by mixing the allyl compound (A) and the thiol compound (C) in the stated order with the mixture, the mixing may be performed by any method. Mixers may be used, such as a tumbler, a ribbon mixer, a rotary mixer, a Henschel mixer, a Banbury mixer, a roller, a Brabender, a single-screw extruder, a multi-screw extruder, a ruder, and a kneader, or stirrers may be used, such as a stirrer having a stirring blade (e.g., a paddle-type stirrer, a propeller-type stirrer, an anchor-type stirrer) and a planetary stirrer having a rotating shaft.

In the step of mixing the maleimide compound (B) and the cyclic compound (D) to obtain a mixture, followed by mixing the allyl compound (A) and the thiol compound (C) in the stated order with the mixture, the mixing may be performed at any temperature. The temperature is preferably 10° C. to 120° C. In consideration of the uniform dispersibility of each component, the temperature is preferably 40° C. or higher, while from the viewpoint of suppressing a side reaction during mixing, the temperature is preferably 100° C. or lower. Thus, the temperature is more preferably 40° C. to 100° C.

The amounts of the allyl compound (A), the maleimide compound (B), the thiol compound (C), and the cyclic compound (D) in the manufacturing method for a thermosetting resin composition of the present invention are preferably the same as the amounts of the four components in the above-described thermosetting resin composition of the present invention.

The manufacturing method for a thermosetting resin composition of the present invention may further include a step other than the above mixing. The method may include one or two or more steps selected from mixing a thermoplastic resin and/or a thermosetting resin other than the maleimide compound (B), mixing a curing agent, and partially carrying out a polymerization reaction of at least one of the components (A) to (D).

The partially carrying out a polymerization reaction of at least one of the components (A) to (D) may be performed on a composition containing only the components (A) to (D) or on a composition further containing a thermal polymerization initiator and/or a photopolymerization initiator. Through such polymerization, a thermosetting resin composition in which at least part of the components (A) to (D) is partially polymerized is obtained.

The polymerization reaction of at least one of the components (A) to (D) may be performed by photochemical or heat reaction to the mixture obtained by mixing the components (A) to (D). The control of the duration of photochemical reaction or the temperature or duration of heat reaction enables carrying out only part of the polymerization reaction. When the polymerization reaction is performed by heat reaction, the heating temperature may be any temperature at which the polymerization reaction proceeds. The heating temperature is preferably 100° C. to 250° C., more preferably 130° C. to 200° C. The duration of the polymerization varies depending on the temperature, and is preferably 10 minutes to 150 minutes, more preferably 30 minutes to 120 minutes.

In a preferred embodiment of the present invention, the manufacturing method for a thermosetting resin composition of the present invention further includes, after the mixing of the components (A) to (D), mixing a thermosetting resin other than the maleimide compound (B) with the mixture. Further, in a preferred embodiment of the present invention, the manufacturing method for a thermosetting resin composition of the present invention further includes, after the mixing of the components (A) to (D), partially carrying out a polymerization reaction of at least one of the components (A) to (D) in the mixture and then mixing a thermosetting resin other than the maleimide compound (B) with the mixture.

In a preferred embodiment of the thermosetting resin composition of the present invention, the thermosetting resin composition containing the components (A) to (D) is used in the form of a mixture with the thermosetting resin other than the maleimide compound (B) as described above. In particular, as described above, it is found that when the thermosetting resin composition of the present invention is partially reacted by heat or photochemical reaction to produce an oligomer, the cured thermosetting resin which is cured after mixing the thermosetting resin containing the oligomer with an epoxy resin and an aromatic diamine compound has excellent bending properties. Thus, in a preferred embodiment of the present invention, the manufacturing method for a thermosetting resin composition of the present invention includes a step for obtaining such a thermosetting resin having excellent bending properties.

### 3. Thermosetting Resin

The following describes a thermosetting resin obtained by curing the thermosetting resin composition of the present invention.

When the thermosetting resin composition of the present invention is cured to produce a thermosetting resin, the curing may be performed at any temperature. From the view point of operability and for sufficient curing of the resin composition, the temperature is preferably 100° C. to 300° C., more preferably 160° C. to 250° C.

When the thermosetting resin composition containing an epoxy resin and an aromatic diamine compound is cured, the curing temperature is preferably 160° C. to 220° C., more preferably 180° C. to 200° C. At such a curing temperature, a thermosetting resin having particularly excellent bending properties is obtained.

The temperature is preferably increased stepwise at predetermined time intervals within the above temperature range.

The thermosetting resin of the present invention preferably has a glass transition temperature of 250° C. or higher.

The thermosetting resin having a glass transition temperature of 250° C. or higher can be used in a reflow process that uses lead-free solder having a melting temperature of 200° C. to 230° C. without problems such as thermal deformation and cracking.

The thermosetting resin of the present invention is a resin obtained by curing the thermosetting resin composition of the present invention as described above, and thus has excellent heat resistance and toughness. Such a thermosetting resin is suitably used for sealing of semiconductors such as LED chips or LSI.

### EXAMPLES

The present invention is described in detail with reference to specific examples below, but the present invention is not limited to these examples. The terms “%” and “wt %” indicate “% by weight (% by mass)”, unless otherwise specified. The properties were measured by the below-described methods.

### Experimental Example 1

First, the period from the completion of melting of a resin composition to the beginning of gelation of the molten resin composition was measured.

A sample was prepared by mixing 14.4 g of 4,4′-diphenylmethane bismaleimide, 4.1 g of 2,2′-diallyl bisphenol A, 1.4 g of tris-[(3-mercaptopropionyloxy)-ethyl]-isocyanurate, and 0.02 g of each compound shown in Table 1. The sample was put into a 50 ml glass jar and melted in an oven at 160° C. The period from the completion of melting of the sample to the beginning of gelation of the molten sample was measured, and evaluation was performed according to the following criteria. In the evaluation, a composition free from any of the compounds shown in Table 1 was used as a blank. The results are shown in Table 1. A N-nitrosophenylhydroxylamine aluminum salt in Table 1 is a compound having a structure represented by the following formula (27).

Excellent: Gelation started 30 minutes or more later than the gelation start time of the blank.
Good: Gelation started 10 to 30 minutes (exclusive of 30 minutes) later than the gelation start time of the blank.
Fair: Gelation started 5 to 10 minutes (exclusive of 10 minutes) later than the gelation start time of the blank.
Poor: Gelation started at the same time as or within less than 5 minutes later than the gelation start time of the blank.

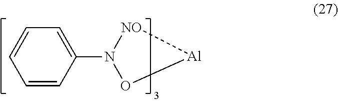

### Experimental Example 2

Experimental Example 2 was performed as in Experimental Example 1 except that the amount of each compound shown in Table 1 was changed to 0.2 g. The period from the completion of melting of a sample to the beginning of gelation of the molten sample was measured by the above-described method, and evaluated according to the above-described criteria. The results are shown in Table 1.

TABLE 1

| | Evaluation result | |
|---|---|---|
| | Experimental | Experimental |
| Chemicals | Example 1 | Example 2 |
| p-Methoxyphenol | Poor | Poor |
| Hydroquinone | Fair | Fair |
| 2,5-Di-t-butylhydroquinone | Fair | Fair |
| 2,5-Dihydroxybenzoquinone | Excellent | Excellent |
| 2,3-Dihydroxynaphthalene | Good | Excellent |
| Pyrogallol | Excellent | Excellent |
| 1,2,4-Benzenetriol | Excellent | Excellent |
| 2,2′,4,4′-Tetrahydroxybenzophenone | Excellent | Excellent |
| N-Nitrosophenylhydroxylamine aluminum | Poor | Poor |
| salt | | |
| p-Toluenesulfonic acid | Poor | Poor |
| Phenothiazine | Poor | Poor |
| Benzoquinone | Poor | Poor |
| Aluminum chloride | Poor | Poor |
| o-Nitrotoluene | Poor | Poor |
| Melamine | Poor | Poor |

### (Materials Used in Examples)

### <Allyl Compound>

(A) 2,2′-Diallyl bisphenol A (DABPA available from Daiwa Kasei Industry Co., Ltd.)

### <Maleimide Compound>

(B) 4,4′-Diphenylmethane bismaleimide (BMI-1100H available from Daiwa Kasei Industry Co., Ltd.)

### <Thiol Compound>

(C) Tris-[(3-mercaptopropionyloxy)-ethyl]-isocyanurate (TEMPIC available from SC Organic Chemical Co., Ltd.)

### <Cyclic Compound>

(D-1) Pyrogallol (Fujifilm Wako Pure Chemical Corporation)

(D-2) 2,3-Dihydroxynaphthalene (Tokyo Chemical Industry Co., Ltd.)

(D-3) 2,2′,4,4′-Tetrahydroxybenzophenone (Tokyo Chemical Industry Co., Ltd.)

(D-4) Hydroquinone (Fujifilm Wako Pure Chemical Corporation)

(D-5) 1,2,4-Benzenetriol (Fujifilm Wako Pure Chemical Corporation)

### <Epoxy Resin>

(E-1) XNR-6815 (NCX)

(E-2) CELLOXIDE 2021P (Daicel Corporation)

### <Maleimide Compound, Etc.>

(F-1) A compound obtained in Synthesis Example 1 described below (oligomer of the thermosetting resin composition containing the components (A) to (D) in the present invention)

(F-2) BMI-1100H (Daiwa Kasei Industry Co., Ltd.)

(F-3) BMI-2300 (Daiwa Kasei Industry Co., Ltd.)

(F-4) DAIMIDE-100 (Daiwa Kasei Industry Co., Ltd.)

### <Curing Agent>

(G-1) SEIKACURE S (Wakayama Seika Kogyo Co., Ltd.)

(G-2) C-100 (Nippon Kayaku Co., Ltd.)

### Example 1

A reactor equipped with a stirring blade and an oil jacket was charged with 43 g of DABPA and 0.02 g of pyrogallol, and the contents were stirred at 80° C. for 25 minutes to give a liquid. To the liquid were added 14.7 g of TEMPIC and 100 g of BMI-1100H, and the contents were stirred for 7 minutes to give a kneaded mixture. The kneaded mixture was transferred to an aluminum cup, and heated in an oven at 160° C. The contents were completely melted, and the pressure was then reduced until no bubbles were generated from the melt. The pressure was returned to atmospheric pressure, and the contents were then heated at 160° C. for 2 hours, at 180° C. for 2 hours, at 200° C. for 2 hours, at 220° C. for 2 hours, and at 240° C. for 2 hours to obtain a cured product 1. The glass transition temperature of the cured product 1 was measured by the below-described method. The fracture toughness was also measured by the below-described method. The results are shown in Table 2.

### Examples 2 to 10

Examples 2 to 10 were performed as in Example 1 except that the amounts of the materials used were changed according to Table 2. Thus, cured products 2 to 10 were obtained. The glass transition temperature of each of the cured products 2 to 10 was measured by the below-described method. The fracture toughness of each of the cured products 2 to 6 was also measured by the following method. The results are shown in Table 2.

### (Fracture Toughness)

A 60 mm×10 mm×3 mm specimen was cut out from each of the cured products obtained in the examples and comparative examples, and subjected to a fracture toughness test using a material universal testing machine (AGS-X available from Shimadzu Corporation) by the method in conformity with ASTM D5045-93. The fracture toughness test was performed at a distance between supporting points of 40 mm, a loading rate of 1 mm/min, and by a three point bending method. Thus, a critical stress intensity factor (K₁c) was calculated as fracture toughness.

### Example 11

First, 0.69 g of pyrogallol was added to 100 g of BMI-1100H, and they were mixed to prepare a mixture. A reactor equipped with a stirring blade and an oil jacket was charged with the mixture, 28.7 g of DABPA, and 9.8 g of TEMPIC, and the contents were stirred at 80° C. for 7 minutes to give a kneaded mixture. The kneaded mixture was transferred to an aluminum cup, and heated in an oven at 160° C. The contents were completely melted, and the pressure was then reduced until no bubbles were generated from the melt. The pressure was returned to atmospheric pressure, and the contents were then heated at 160° C. for 2 hours, at 180° C. for 2 hours, at 200° C. for 2 hours, at 220° C. for 2 hours, and at 240° C. for 2 hours to obtain a cured product 11. The glass transition temperature of the cured product 11 was measured by the below-described method. The fracture toughness was also measured by the above-described method. The results are shown in Table 2.

TABLE 2

| | | Example 1 | | Example 2 | | Example 3 | | Example 4 | | Example 5 | | Example 6 | |
|---|---|---|---|---|---|---|---|---|---|---|---|---|---|
| Formulation | DABPA/BMI/TEMPIC | 1/2/0.2 | | 1/2/0.2 | | 1/2/0.2 | | 1/2/0.2 | | 1/2/0.2 | | 1/3/0.2 | |
| | molar ratio | | | | | | | | | | | | |
| | A | 43.0 | g | 43.0 | g | 43.0 | g | 43.0 | g | 43.0 | g | 28.7 | g |
| | B | 100.0 | g | 100.0 | g | 100.0 | g | 100.0 | g | 100.0 | g | 100.0 | g |
| | C | 14.7 | g | 14.7 | g | 14.7 | g | 14.7 | g | 14.7 | g | 9.8 | g |
| | D-1 | 0.02 | g | 0.32 | g | 0.47 | g | 0.79 | g | 1.10 | g | 0.69 | g |

| | D-2 | | — | — | — | — | — | — |
|---|---|---|---|---|---|---|---|---|
| | D-3 | | — | — | — | — | — | — |
| | D-4 | | — | — | — | — | — | — |
| | D-5 | | — | — | — | — | — | — |
| Evaluation of | Glass transition | [° C.] | 294 | 296 | 291 | 295 | 297 | 350_{↑} |
| cured product | temperature (Tg) | | | | | | | |
| | Fracture | [MPa · m^{1/2}] | 0.79 | 0.79 | 0.79 | 0.79 | 0.78 | 0.76 |
| | toughness | | | | | | | |

| | | Example 7 | Example 8 | Example 9 | Example 10 | Example 11 |
|---|---|---|---|---|---|---|
| Formulation | DABPA/BMI/TEMPIC | 1/2/0.2 | 1/2/0.2 | 1/2/0.2 | 1/2/0.2 | 1/3/0.2 |
| | molar ratio | | | | | |

| | | | | | | | | | | |
|---|---|---|---|---|---|---|---|---|---|---|
| A | 43.0 | g | 43.0 | g | 43.0 | g | 43.0 | g | 28.7 | g |
| B | 100.0 | g | 100.0 | g | 100.0 | g | 100.0 | g | 100.0 | g |
| C | 14.7 | g | 14.7 | g | 14.7 | g | 14.7 | g | 9.8 | g |

| | | | | | | |
|---|---|---|---|---|---|---|
| D-1 | — | — | — | — | 0.69 | g |

| | | | | | | |
|---|---|---|---|---|---|---|
| D-2 | 0.79 | g | — | — | — | — |

| | | | | | | |
|---|---|---|---|---|---|---|
| D-3 | — | 0.79 | g | — | — | — |

| | | | | | | |
|---|---|---|---|---|---|---|
| D-4 | — | — | 0.79 | g | — | — |

| | | | | | | |
|---|---|---|---|---|---|---|
| D-5 | — | — | — | 0.79 | g | — |

| | | | | | | | |
|---|---|---|---|---|---|---|---|
| Evaluation of | Glass transition | [° C.] | 306 | 310 | 302 | 292 | 307 |
| cured product | temperature (Tg) | | | | | | |
| | Fracture | [MPa · m^{1/2}] | — | — | — | — | 0.75 |
| | toughness | | | | | | |

### Comparative Examples 1 to 5

Comparative Examples 1 to 5 were performed as in Example 1 except that the amounts of the materials used were changed according to Table 3. Thus, comparative cured products 1 to 5 were obtained. The glass transition temperature of each of the comparative cured products 1 to 5 was measured by the below-described method. The fracture toughness was also measured by the above-described method. The results are shown in Table 3.

### Example 12

A reactor equipped with a stirring blade and an oil jacket was charged with 28.7 g of DABPA and 9.8 g of TEMPIC, and the contents were stirred at 50° C. for 20 minutes to give a liquid. To the liquid were added 0.69 g of pyrogallol and 100 g of BMI-1100H, and the contents were stirred for 7 minutes to give a kneaded mixture. The kneaded mixture was transferred to an aluminum cup, and heated in an oven at 160° C. The contents were completely melted, and the pressure was then reduced until no bubbles were generated from the melt. The pressure was returned to atmospheric pressure, and the contents were then heated at 160° C. for 2 hours, at 180° C. for 2 hours, at 200° C. for 2 hours, at 220° C. for 2 hours, and at 240° C. for 2 hours to obtain a cured product 12. The glass transition temperature of the cured product 12 was measured by the below-described method. The results are shown in Table 3.

TABLE 3

| | | Comparative | | Comparative | | Comparative | | Comparative | | Comparative | | | |
|---|---|---|---|---|---|---|---|---|---|---|---|---|---|
| | | Example 1 | | Example 2 | | Example 3 | | Example 4 | | Example 5 | | Example 12 | |
| Formulation | DABPA/BMI/TEMPIC | 1/2/0.2 | | 1/2/0 | | 1/2/0 | | 1/3/0 | | 1/3/0 | | 1/3/0.2 | |
| | molar ratio | | | | | | | | | | | | |
| | A | 43.0 | g | 43.0 | g | 43.0 | g | 28.7 | g | 28.7 | g | 28.7 | g |
| | B | 100.0 | g | 100.0 | g | 100.0 | g | 100.0 | g | 100.0 | g | 100.0 | g |

| | | | | | | | | |
|---|---|---|---|---|---|---|---|---|
| C | 14.7 | g | — | — | — | — | 9.8 | g |

| | | | | | | | | | |
|---|---|---|---|---|---|---|---|---|---|
| D-1 | — | — | 0.79 | g | — | 0.69 | g | 0.69 | g |

| | D-2 | | — | — | — | — | — | — |
|---|---|---|---|---|---|---|---|---|
| | D-3 | | — | — | — | — | — | — |
| | D-4 | | — | — | — | — | — | — |
| | D-5 | | — | — | — | — | — | — |
| Evaluation of | Glass transition | [° C.] | 281 | 302 | 292 | 350↑ | 305 | 296 |
| cured product | temperature (Tg) | | | | | | | |
| | Fracture | [MPa · m^{1/2}] | 0.80 | 0.57 | 0.59 | 0.45 | 0.49 | — |
| | toughness | | | | | | | |

### Examples 13 to 15

Examples 13 to 15 were performed as in Example 1 except that the amounts of the materials used were changed according to Table 4. Thus, cured products 13 to 15 were obtained. The glass transition temperature, bending strength, flexural modulus, and elongation at break of each of the cured products 13 to 15 were evaluated by the below-described methods. The cured product 6 obtained in Example 6 was also subjected to the same evaluations. The results are shown in Table 4.

### (Glass Transition Temperature)

A 60 mm×10 mm×3 mm specimen was cut out from each of the cured products obtained in the examples and comparative examples, and subjected to measurement using a dynamic viscoelastometer (EXSTAR6000 available from SII NanoTechnology Inc.) by the method in conformity with JIS K-7244 (1998). The measurement was performed at a temperature rise rate of 2° C./min, a frequency of 1 Hz, and in a bending mode. Thus, a loss tangent curve was obtained. The peak top of the loss tangent curve was defined as a glass transition temperature.

### (Bending Strength, Flexural Modulus, Elongation at Break)

A 70 mm×10 mm×3 mm specimen was cut out from each of the cured products obtained in the examples and comparative examples, and subjected to a three point bending test using a material universal testing machine (AGS-X available from Shimadzu Corporation) by a method in conformity with JIS K-6911 (2006). The three point bending test was performed at a distance between supporting points of 48 mm and a loading rate of 1.5 mm/min. Thus, the bending strength, flexural modulus, and elongation at break were determined.

TABLE 4

| | | Example 13 | | Example 14 | | Example 15 | | Example 6 | |
|---|---|---|---|---|---|---|---|---|---|
| Formulation | DABPA/BMI/TEMPIC | 1/3/0.2 | | 1/3/0.2 | | 1/2/0.2 | | 1/3/0.2 | |
| | molar ratio | | | | | | | | |
| | A | 28.7 | g | 28.7 | g | 43.0 | g | 28.7 | g |
| | B | 100.0 | g | 100.0 | g | 100.0 | g | 100.0 | g |
| | C | 9.8 | g | 9.8 | g | 14.7 | g | 9.8 | g |
| | D-1 | 2.08 | g | 4.15 | g | 2.37 | g | 0.69 | g |

| | | | | | | |
|---|---|---|---|---|---|---|
| Evaluation of | Glass transition | [° C.] | 300 | 328 | 289 | 350↑ |
| cured product | temperature (Tg) | | | | | |
| | Bending strength | [MPa] | 214 | 240 | 227 | 192 |
| | Flexural modulus | [GPa] | 3.7 | 3.9 | 4.0 | 3.8 |
| | Elongation at break | [%] | 9.4 | 9.6 | 8.9 | 7.9 |

### Synthesis Example 1

A reactor equipped with a stirring blade and an oil jacket was charged with 28.7 g of DABPA and 0.69 g of pyrogallol, and the contents were stirred at 80° C. for 25 minutes to give a liquid. To the liquid were added 9.8 g of TEMPIC and 100 g of BMI-1100H, and the contents were stirred for 7 minutes to give a kneaded mixture similar to the kneaded mixture obtained in Example 6. Then, the oil jacket was heated to 160° C., and the contents were stirred for 30 minutes to partially carry out the polymerization reaction to give a liquid. The liquid was cooled to room temperature and was solidified. The solidified product was pulverized with a coffee mill to give a product F-1.

### Example 16

A reactor equipped with a stirring blade and an oil jacket was charged with 100 g of XNR-6815, 30 g of the product F-1 obtained in Synthesis Example 1, and 39 g of SEIKACURE S, and the contents were stirred at 130° C. for 10 minutes to give a liquid. The liquid was transferred to an aluminum cup, and heated at 200° C. for 2 hours. Thus, a cured product 16 was obtained. The glass transition temperature, bending strength, flexural modulus, and bending displacement of the cured product 16 were measured by the same methods as in Examples 13 to 15. The results are shown in Table 5.

### Examples 17 to 22

Examples 17 to 22 were performed as in Example 16 except that the types and amounts of the materials used were changed according to Table 5. Thus, cured products 17 to 22 were obtained. The glass transition temperature, bending strength, flexural modulus, and bending displacement of each of the cured products 17 to 22 were evaluated by the same methods as in Example 16. The results are shown in Table 5.

### Comparative Examples 6 to 11

Comparative Examples 6 to 11 were performed as in Example 16 except that the types and amounts of the materials used were changed according to Table 5. Thus, comparative cured products 6 to 11 were obtained. The glass transition temperature, bending strength, flexural modulus, and bending displacement of each of the comparative cured products 6 to 11 were evaluated by the same methods as in Example 16. The results are shown in Table 5.

TABLE 5

| | | | Comparative | | | | | Comparative | |
|---|---|---|---|---|---|---|---|---|---|
| | | | Example 6 | Example 16 | Example 17 | Example 18 | Example 19 | Example 7 | Example 20 |
| Formulation | E-1 | | 100 | 100 | 100 | 100 | — | — | — |
| | E-2 | | — | — | — | — | — | 100 | 100 |
| | F-1 | | — | 30 | 60 | 100 | 100 | — | 30 |
| | F-2 | | — | — | — | — | — | — | — |
| | F-3 | | — | — | — | — | — | — | — |
| | F-4 | | — | — | — | — | — | — | — |
| | G-1 | | 30 | 39 | 47 | 60 | 30 | 50 | 59 |
| | G-2 | | — | — | — | — | — | — | — |
| Evaluation of cured | Glass transition | [° C.] | 146 | 171 | 174 | 185 | 250 | 194 | 214 |
| product | temperature (Tg) | | | | | | | | |
| | Bending strength | [MPa] | 149 | 166 | 174 | 187 | 200 | 124 | 180 |
| | Flexural modulus | [GPa] | 3.0 | 3.1 | 3.1 | 3.4 | 3.8 | 3.7 | 3.8 |
| | Bending | [mm] | 12 | 17 | 15 | 9 | 6 | 4 | 10 |
| | displacement | | | | | | | | |

| | | | | Comparative | | Comparative | Comparative | Comparative |
|---|---|---|---|---|---|---|---|---|
| | | | Example 21 | Example 8 | Example 22 | Example 9 | Example 10 | Example 11 |
| Formulation | E-1 | | — | 100 | 100 | 100 | 100 | 100 |
| | E-2 | | 100 | — | — | — | — | — |
| | F-1 | | 100 | — | 30 | — | — | — |
| | F-2 | | — | — | — | 30 | — | — |
| | F-3 | | — | — | — | — | 30 | — |
| | F-4 | | — | — | — | — | — | 30 |
| | G-1 | | 80 | — | — | 39 | 39 | 39 |
| | G-2 | | — | 30 | 39 | — | — | — |
| Evaluation of cured | Glass transition | [° C.] | 225 | 110 | 123 | 157 | 152 | 160 |
| product | temperature (Tg) | | | | | | | |
| | Bending strength | [MPa] | 190 | 125 | 160 | 140 | 134 | 120 |
| | Flexural modulus | [GPa] | 3.8 | 2.8 | 3.2 | 3.1 | 3.4 | 2.8 |
| | Bending | [mm] | 5 | 16 | 20 | 10 | 9 | 10 |
| | displacement | | | | | | | |

The results of the examples and comparative examples demonstrated the followings.

The results in Table 1 demonstrated that the resin compositions each containing the allyl compound (A), the maleimide compound (B), and the thiol compound (C) in the present invention, and a compound corresponding to the cyclic compound (D) were less likely to gel and had excellent handleability.

The results in Tables 2 to 4 demonstrated that the resin compositions each containing the allyl compound (A), the maleimide compound (B), the thiol compound (C), and the cyclic compound (D) provide cured products having excellent toughness and heat resistance.

Comparing Comparative Example 2 with Comparative Example 3 in Table 3 demonstrated that addition of the cyclic compound (D) to the resin composition containing only the allyl compound (A) and the maleimide compound (B) but not the thiol compound (C) rather reduced heat resistance. This also applies to the case of comparing Comparative Example 4 with Comparative Example 5. These results demonstrated that the effects of addition of the cyclic compound (D) were exhibited in the case where the cyclic compound (D) was added to the resin composition containing the allyl compound (A), the maleimide compound (B), and the thiol compound (C). The resin compositions of Comparative Examples 2 and 4 have high glass transition temperatures, but have low toughness because they are free from a thiol compound as shown in Table 3.

In the production of the resin compositions, the resin composition of Example 6 was produced by a step of mixing the allyl compound (A) and the cyclic compound (D) to obtain a mixture, followed by mixing the thiol compound (C) and the maleimide compound (B) in the stated order with the mixture, the resin composition of Example 11 was produced by a step of mixing the maleimide compound (B) and the cyclic compound (D) to obtain a mixture, followed by mixing the allyl compound (A) and the thiol compound (C) in the stated order with the mixture, and the resin composition of Example 12 was produced by mixing these components in any order other than these orders. Comparing the resin compositions of Examples 6 and 11 with the resin composition of Example 12 demonstrated that although these resin compositions had the same formulation of the four components, the resin compositions of Examples 6 and 11 provided cured products having higher heat resistance than the resin composition of Example 12. In particular, the cured product of the resin composition of Example 6 had particularly excellent heat resistance. This demonstrated that the resin compositions produced by blending the four components in particular orders had particularly excellent heat resistance.

The results in Table 4 demonstrated that the compositions of Examples 13 to 15 containing the cyclic compound (D) in an amount of 1.2 parts by weight or more and 6.0 parts by weight or less relative to 100 parts by weight of the maleimide compound (B) provided cured products having higher bending strength and elongation at break than the cured product of Example 6.

The results in Table 5 demonstrated that the cured product obtained by mixing the thermosetting resin composition of the present invention and an epoxy resin had excellent heat resistance and excellent bending properties.

Further, Examples 16, 17, and 20 demonstrated that the resins obtained by mixing an epoxy resin and an aromatic diamine compound such that the epoxy resin and the sum of the components (A) to (D) in the thermosetting resin composition of the present invention had a specific ratio, and thermally curing the mixture had specific bending properties.

It was also demonstrated that the resins of Examples 20 and 21 in which another type of epoxy resin was used and the resin of Example 22 in which another type of aromatic diamine was used also had excellent bending properties, and thus the above effect does not depend on the structure of the epoxy resin or the structure of the aromatic diamine.

On the other hand, in Comparative Examples 9 to 11 in which a commercially available maleimide compound was used instead of the thermosetting resin composition of the present invention containing the components (A) to (D), excellent bending properties cannot be obtained even if an epoxy resin and an aromatic diamine compound were mixed. This demonstrated that the effect that excellent bending properties can be obtained by adding an epoxy resin and an aromatic diamine compound is an effect specific to the thermosetting resin composition of the present invention.

1. A thermosetting resin composition comprising:
an allyl compound (A) containing at least two or more allyl groups and one or more benzene rings in a molecule;
a maleimide compound (B) containing at least two or more maleimide groups in a molecule;
a thiol compound (C) containing at least two or more thiol groups in a molecule; and
a cyclic compound (D) containing at least two or more hydroxyl groups in a molecule.

2. The thermosetting resin composition according to claim 1,
wherein the cyclic compound (D) is an aromatic compound or a quinone compound.

3. The thermosetting resin composition according to claim 1,
wherein the thermosetting resin composition contains the cyclic compound (D) in a ratio of 0.01 parts by weight or more and 6.0 parts by weight or less relative to 100 parts by weight of the maleimide compound (B).

4. The thermosetting resin composition according to claim 3,
wherein the thermosetting resin composition contains the cyclic compound (D) in a ratio of 0.01 parts by weight or more and less than 1.2 parts by weight relative to 100 parts by weight of the maleimide compound (B).

5. The thermosetting resin composition according to claim 3,
wherein the thermosetting resin composition contains the cyclic compound (D) in a ratio of 1.2 parts by weight or more and 6.0 parts by weight or less relative to 100 parts by weight of the maleimide compound (B).

6. The thermosetting resin composition according to claim 1, further comprising a thermosetting resin other than the maleimide compound (B).

7. The thermosetting resin composition according to claim 6,
wherein the thermosetting resin other than the maleimide compound (B) is an epoxy resin.

8. The thermosetting resin composition according to claim 6,
wherein a sum of weights of the components (A), (B), (C), and (D) is 10 parts by weight or more and 80 parts by weight or less relative to 100 parts by weight of the thermosetting resin other than the maleimide compound (B).

9. A thermosetting resin obtained by curing the thermosetting resin composition according to claim 1.

10. A manufacturing method for a thermosetting resin composition, comprising: mixing
an allyl compound (A) containing at least two or more allyl groups and one or more benzene rings in a molecule,
a maleimide compound (B) containing at least two or more maleimide groups in a molecule,
a thiol compound (C) containing at least two or more thiol groups in a molecule, and
a cyclic compound (D) containing at least two or more hydroxyl groups in a molecule.

11. The manufacturing method for a thermosetting resin composition according to claim 10,
wherein the mixing is either
a step of mixing the allyl compound (A) and the cyclic compound (D) to obtain a mixture, followed by mixing the thiol compound (C) and the maleimide compound (B) in the stated order with the mixture or
a step of mixing the maleimide compound (B) and the cyclic compound (D) to obtain a mixture, followed by mixing the allyl compound (A) and the thiol compound (C) in the stated order with the mixture.

12. The manufacturing method for a thermosetting resin composition according to claim 10, further comprising, after the mixing, mixing a thermosetting resin other than the maleimide compound (B) with the mixture.

13. The manufacturing method for a thermosetting resin composition according to claim 10, further comprising, after the mixing, partially carrying out a polymerization reaction of at least one of the components (A) to (D) in the mixture and then mixing a thermosetting resin other than the maleimide compound (B) with the mixture.
